(19) United States
(12) Patent Application Publication
(10) Pub. No.: US 2026/0329553 A1
(43) Pub. Date: Oct. 22, 2026

(54) SYSTEM AND METHOD OF USING ARTIFICIALLY INTELLIGENT AGENTS FOR AUTOMATING LIPIDOMICS EXPERIMENTS AND ANALYSIS

(71) Applicant: Purdue Research Foundation, West Lafayette, IN (US)

(72) Inventors: Gaurav Chopra, West Lafayette, IN (US); Connor Beveridge, West Lafayette, IN (US); Sanjay Iyer, Lafayette, IN (US); Matthew Muhoberac, Indianapolis, IN (US)

(73) Assignee: Purdue Research Foundation, West Lafayette, IN (US)

(21) Appl. No.: 19/458,475

(22) Filed: Jan. 23, 2026

Related U.S. Application Data
(63) Continuation-in-part of application No. PCT/US25/16254, filed on Feb. 17, 2025.
(60) Provisional application No. 63/554,874, filed on Feb. 16, 2024.
(60) Provisional application No. 63/751,174, filed on Jan. 29, 2025.

(51) Int. Cl. G06F 8/35

(52) U.S. Cl. CPC G06F 8/35

(57) ABSTRACT

A method of applying artificial intelligence (AI) to automate lipidomics experiments and analysis includes establishing an AI agent configured to communicate with an external entity, a large language model (LLM), a sensor, and an actuator, wherein communication between the external entity and the AI agent is analyzed and generated by the LLM thus establishing conversational communication between the external entity and the AI agent, analyzing queries from the external entity, determining if a tool exist in a toolkit to be used to address the external entity query, if a tool exists, the AI agent generating input for the identified tool and executes the identified tool with generated input, if no tool is identified to exist, the AI agent generating code and new-tool inputs for a new tool and executes the new tool with the generated code and the new-tool inputs, and adding the new tool to the toolkit.

### CROSS-REFERENCE TO RELATED APPLICATIONS

The present non-provisional patent application is a continuation-in-part of International Patent Application Serial No. PCT/US25/16254, filed Feb. 17, 2025 which is related to and claims the priority benefit of U.S. Provisional Patent Application Ser. No. 63/554,874, filed Feb. 16, 2024, and is related to and claims the priority benefit of U.S. Provisional Patent Application Ser. No. 63/751,174, filed Jan. 29, 2025, the contents of each of which are hereby incorporated by reference in its entirety into the present disclosure.

### GOVERNMENT SUPPORT CLAUSE

This invention was made with government support under U18TR004146 awarded by the National Institutes of Health, under W81XWH2010665 awarded by the United States Department of Defense USAMRAA, and under MCDC2202-003 awarded by the Defense Threat Reduction Agency (DTRA) AIMS-HITS. The government has certain rights in the invention.

### TECHNICAL FIELD

The present disclosure generally relates to an artificial intelligence (AI) based tool, and in particular to an AI system that can communicate with a client, whether a human or a computer-based system, via large language models (LLMs) as an application related to a system and method of using artificially intelligent agents for automating lipidomics experiments and analysis.

### BACKGROUND

This section introduces aspects that may help facilitate a better understanding of the disclosure. Accordingly, these statements are to be read in this light and are not to be understood as admissions about what is or is not prior art.

Lipids are universal biomolecules that are integral to an array of cellular processes, such as cell signaling, energy conservation, metabolic regulation, and the maintenance of cellular structure. In the past decade, there has been a significant increase in lipidomic research due to advancements in mass spectrometry (MS) technologies and recognition in the community that changes in lipid metabolism plays a major role in disease pathologies. For example, chronic diseases, such as Alzheimer's disease (AD), cancer, type 2 diabetes, cardiovascular disease, among others, have shown altered lipid profiles related to disease onset and progression. Therefore, detailed lipidome investigations can identify how specific metabolic pathways influences cellular functions and how specific lipids affect health and disease pathogenesis.

Despite the importance of detailed lipidome profiling, the precise characterization, identification, and quantification of lipids presents significant challenges. MS has emerged as a popular tool in lipidomic analysis, owing to its exceptional sensitivity, specificity, and versatility. There exists a set of hierarchical structural information for detailed lipid identification. Lipids can be separated based on class and sum composition that includes the sum of carbon atoms and degree of unsaturation at the lowest hierarchy. The lipid classification system proposed by the LIPID MAPS® consortium classifies lipid structures into eight main categories: fatty acyls (FA), glycerolipids (GL), glycerophospholipids (GP), sphingolipids (SP), sterol lipids (ST), prenol lipids (PR), saccharolipids (SL), and polyketides (PK). Within each lipid category, there exists further structural hierarchical levels including an array of lipid classes and subclasses. Such structural assignments can be readily obtained from conventional MS and tandem-MS (MS/MS) experiments. Independent of ionization mode, lipid precursor ions can be identified at a sum compositional level via accurate mass measurements (i.e., observed mass-to-charge (m/z) ratios). Additional structural information can be obtained by utilizing collision-induced dissociation (CID). For example, individual GP classes like glycerophosphoethanolamines (PEs), glycerophosphoglycerols (PGs), glycerophosphoserines (PSs), glycerophosphoinositols (PIs), glycerophosphocholines (PCs) and sphingomyelin (SM) can be detected and identified based on class-specific fragmentation that relate to GP headgroup composition. Additionally, in negative ion mode, MS/MS of deprotonated acidic GP anions results in the cleavage of ester bonds at the sn-1 and sn-2 positions of anionic GP. In turn, fatty acyl chains are liberated from the anionic GP precursor ion, yielding abundant carboxylate anions that permit the assignment of fatty acyl sum composition and, in some cases, GP subclass assignment.

Recently, multiple reaction monitoring (MRM)-profiling has demonstrated success for large-scale lipid profiling. Briefly, MRM-profiling is a shotgun MS/MS technique for the exploratory analysis of lipids. MRM-profiling facilitates the concurrent analysis of up to thousands of individual precursor/product ion pair transitions in a single sample injection, allowing for the efficient generation of large amounts of lipidomic data that should be analyzed using statistically robust methods to identify up-and downregulated lipids. MRM transitions can be predicted and subsequently generated by exploiting lipid class-specific fragmentation patterns in conjunction with lipid database information. In general, the precursor ion is the expected ionized m/z of the lipid molecule at its class or species level, while the product ion is the expected m/z for a headgroup or fatty acyl neutral loss from the lipid precursor ion. The combination of the precursor and product ion pair constitutes the MRM transition. Although MRM-profiling is limited to exploratory analysis, the identified lipid targets and are in good agreement with LC-MS/MS lipidomics profiling results.

While conventional tandem-MS experiments including MRM-profiling are effective, they have inherent limitations specifically related to isomeric lipids resolution varying in carbon-carbon double bond position and geometry. We note that while basic lipid identification using lipid class and sum composition identifiers can provide substantial biological insights, deep lipid structural identification is required to fully understand lipid roles, behavior, and identify new targets and biomarkers in metabolic and disease state perturbations. For example, lipid identification at the carbon-carbon double bond (C═C) level has proven useful in differentiating between cancerous and healthy cells. In addition, it was demonstrated that only quantitative analysis of lipid C═C location was sufficient to discriminate gefitinib-resistant cells from a population of gefitinib-sensitive cells.

To aid in isomeric resolution, MS-based methods are often coupled with chromatography, novel-ion activation techniques, and chemical conjugation strategies. Ozone electrospray ionization (OzESI) and ozone induced dissociation (OzID) have proven highly successful for the detailed identification of unsaturated lipid structures. Briefly, OzESI-MS permits the elucidation of C═Cs within unsaturated lipid structures using ozone-induced fragmentation with the source of a conventional ESI mass spectrometer. In-source ozone can be generated either via (1) a corona discharge at the ESI capillary in an oxygen atmosphere or via (2) an external ozone generator. Upon exposure to ozone, unsaturated lipid ions will undergo facile cleavage at each C═C position. Thus, OzESI-MS results in chemically induced fragment ions that reveal C═C position(s). While effective and easy to implement on commercial platforms, OzESI-MS relies on ozone exposure prior to mass selection. In turn, lipidomics datasets can quickly become difficult to interpret. Therefore, interfacing with liquid chromatography (LC) can reduce complexity in these datasets, but manual interpretation can still be overwhelming and laborious, especially when developing high throughput workflows. In turn, large-scale lipidomics dataset processing, such as those generated by MRM-profiling, are inherently prone to human error and bias.

Currently, comprehensive solutions and standards for MRM-lipidomics data analysis have yet to be established. Various public tools exist that cater to specific parts of the lipidomics data collection and analysis workflow, but overall, the process remains largely manual. Moreover, there is no standardized data processing and statistical analysis workflow for large-scale lipidomics data analysis which encompasses parsing raw data files, peak annotation, lipid identification, robust statistical and pathway analysis. Consequently, variations in data processing pipelines and choice of statistical analysis leads to vastly different interpretations and presentations of lipidomics data. In addition, one of the largest challenges faced by modern lipidomics is to keep informatic pipelines sustainable, adaptable, and reproducible, given the rapidly changing landscape of MS-based lipidomics technologies. Therefore, it is essential that future lipidomics analysis pipelines are reliable and robust, and incorporate updated lipidomics standardization, such as suggested nomenclature and data presentation guidelines.

MS and MRM Profiling is a highly versatile, sensitive, and selective analytical technique implemented across a broad range of scientific disciplines ranging from chemistry to biology to physics for the identification, characterization, and quantitation of chemical compounds. In drug discovery, MS is critical for identifying active ingredients, metabolites, and impurities, providing detailed insights into drug composition and behavior. In material science, MS characterizes structural information, helping to understand and develop new materials with desired properties. Environmental science relies on MS for detecting pollutants, including pesticides and heavy metals, crucial for monitoring and maintaining environmental health. Additionally, in the realm of forensic science, MS is indispensable for identifying trace molecules in cases with chemical and biological relevance, including the analysis of explosives, dyes, and blood doping substances. Finally, though not exhaustive, in metabolomics, and more recently lipidomics, MS has emerged as the tool of choice for comprehensive metabolome/lipidome profiling, facilitating the identification of potential biomarkers within complex biological samples and shedding light on the crucial roles of various metabolic processes in relation to disease states.

In general, the first step of any MS experiment requires the introduction of the sample into the ion source to generate analyte ions. Two primary approaches exist for sample introduction. In the first, complex samples are first separated via chromatographic methods like liquid chromatography (LC) prior to analyte ionization. Importantly, LC separation can reduce sample complexity, and in turn, aid in analyte detection and quantitation by reducing ion suppression effects. Considering lipidomics, where the goal is comprehensive identification and quantification of all lipid species in a given sample, LC-MS approaches are particularly useful for low abundant or neutral lipid molecular species, where ion suppression can significantly impact detection. Although LC-MS analysis has become a mainstay of many lipidomics experiments, extensive chromatographic optimizations are often demanded to improve conditions enhancing the selectivity and sensitivity of the analytes of interest.

In the second approach, samples are directly infused into the mass spectrometer ion source without prior chromatographic separation. Known as direct infusion (i.e., shotgun) MS, this approach relies solely on the identification of analyte ion chemical composition based on an accurate mass measurement achieved through an observed mass-to-charge ratio (m/z). Additional structural information regarding chemical composition can be obtained via the fragmentation of precursor analyte ions with low-energy collisions. This technique is referred to as tandem-MS (MS/MS), and in short, exploits dissociation patterns of intact precursor ions, aiming to define the original precursor ion structure in its entirety.

Recently, multiple reaction monitoring (MRM) profiling has gained popularity for the rapid, robust screening of large numbers of targeted chemical species. In short, MRM-profiling is a direct infusion approach that relies on the simultaneous monitoring of precursor and product ion transition pairs. Therefore, only precursor and product ion pairs defined in the method are selectively detected and quantified. This directed approach can achieve higher sensitivity and specificity compared to traditional full scan and tandem-MS approaches, making it particularly effective in identifying and quantifying low-level analytes in complex matrices. For this reason, MRM profiling has demonstrated great success in lipidomics applications, serving as a robust and highly effective approach to profile biological samples for thousands of lipid structures.

Common issues in mass spectrometry data acquisition and analysis include challenges that currently exist in the mass spectrometry worklist construction, peak annotation, and data analysis. Our previous work Old Comprehensive Lipidomic Automation Workflow (OLD-CLAW), see disclosure incorporated by reference into the present disclosure (International Patent Application Serial No. PCT/US25/16254, filed Feb. 17, 2025 which is related to and claims the priority benefit of U.S. Provisional Patent Application Ser. No. 63/554,874, filed Feb. 16, 2024) addressed these challenges by offering a comprehensive end-to-end lipidomics platform. OLD-CLAW can automatically generate worklists, parse/annotate experimental data and perform statistical analysis. Although worklists are now automatically generated, preventing transcription errors, users must still input parameters correctly to get meaningful results. Users must decide the sequence of sample characterization, the number of technical replicates, the number of cleans between samples, and the placement of quality control samples. Deciding the optimal number and type of cleaning runs between samples is dependent on the nature of the sample and is crucial to prevent cross-contamination and carryover effects. In addition, selecting the appropriate number of technical replicates requires balancing the desired level of precision with the amount of available sample, necessitating both knowledge and experience to determine optimal values.

Thus, there remain an unmet need for mass spectrometry tools, such as the automatic worklist generator, to be integrated with Artificially Intelligent (AI) agents for automating lipidomics experiments and analysis.

### SUMMARY

An artificial intelligence (AI) system is disclosed. The system includes a processor executing software a non-transient memory. The processor is configured to establish at least one AI agent each configured to communicate with an external entity, one or more large language models (LLMs), one or more sensors, and one or more actuators. Communication between the external entity and the at least one AI agent is analyzed and generated by the one or more LLMs thus establishing conversational communication between the external entity and the at least one AI agent. The processor is further configured to analyze queries from the external entity, and determine if a tool from a predetermined toolkit exist to be used to address the external entity query. If a tool is identified to exist, the at least one AI agent generates input for the identified tool and executes the identified tool with the generated input. If no tool is identified to exist, the at least one AI agent generates code and new-tool inputs for a new tool and executes the new tool with the generated code and the new-tool inputs and adds the new tool to the predetermined toolkit.

According to one embodiment, in the above AI system the external entity is a human.

According to one embodiment, in the above AI system the external entity is a computing device.

A method of applying artificial intelligence (AI) to automate lipidomics experiments and analysis is also disclosed. The method includes establishing at least one AI agent each configured to communicate with: an external entity, one or more large language models (LLMs), one or more sensors, and one or more actuators. Communication between the external entity and the at least one AI agent is analyzed and generated by the one or more LLMs thus establishing conversational communication between the external entity and the at least one AI agent, analyzing queries from the external entity, and determining if a tool from a predetermined toolkit exist to be used to address the external entity query. If a tool is identified to exist, the method further includes the at least one AI agent generating input for the identified tool and executes the identified tool with the generated input. If no tool is identified to exist, the method further includes the at least one AI agent generating code and new-tool inputs for a new tool and executes the new tool with the generated code and adding the new tool to the predetermined toolkit.

According to one embodiment, in the above method the external entity is a human.

According to one embodiment, in the above method the external entity is a computing device.

### BRIEF DESCRIPTION OF FIGURES

FIGS. 1a-1e, which provide an overview of AI driven lipidomic process, according to the present disclosure, specifically, AI co-pilot functionality communication flowchart including human to agent and agent to agent communication (FIG. 1a), AI guided MRM worklist generation for Agilent MassHunter software (FIG. 1b), AI assisted comparative analysis of lipidomic samples (FIG. 1c), generalized data analysis and plotting of comparative lipidomic results using cloud-based, sandboxed code environments (FIG. 1d), and AI assisted summarization and citation of instrument documentation (FIG. 1e).

FIG. 1f provides an example of an agentic trace of New Comprehensive Lipidomic Automation Workflow (New-CLAW, or simply CLAW) worklist interaction.

FIG. 2a-2b are schematics that provide an overview of AI-driven CLAW process, specifically, FIG. 2a provides an AI guided MRM worklist generation for Agilent MassHunter software, FIG. 2b provides an AI assisted comparative analysis of lipidomic samples.

FIGS. 3a-3d provide a short overview demonstrating the capabilities of the AI agents for automating lipidomics experiments and analysis using large language models, specifically, FIG. 3a provides an AI guided MRM worklist generation for Agilent MassHunter software, FIG. 3b provides an AI assisted comparative analysis of lipidomic samples, FIG. 3c provides a generalized data analysis and plotting of comparative lipidomic results using cloud-based, sandboxed code environments, and FIG. 3d provides a schematic of specific instrument documentation and method development.

FIG. 3e is a plot of density vs. LogFC (Log2 Fold Change) for different types of lipid types including PE, TAG, DAG, PC, PI, FA, PG, and PS.

FIG. 3f provides an example of how a user asks CALW AI agent for top 5 differentially regulated lipids in each direction.

FIG. 3g is bar plot of lipid type vs. number of lipids, showing number of up and down regulated lipids of each type with False Discovery Rate (FDR) <0.1.

FIG. 3h is a pie-chart showing number of lipids of each class with FDR <1 for lipid types including PE, TAG, DAG, PC, PI, FA, PG, and PS.

FIG. 3i is a graph of density vs. LogFC for different lipid classes1for lipid types including PE, TAG, DAG, PC, PI, FA, PG, and PS.

FIG. 3j is an example of an agentic trace of user-defined statistical analysis on comparative lipidomic data.

FIGS. 4a-4g provide example input to an output from an AI co-pilot for general data analysis, pecifically, FIG. 4a provides a map of how the user provides definition of the lipidomic comparative statistical results file; FIG. 4b provides how a human-agent interaction on general statistical questions on lipid upregulation and downregulation; FIG. 4c provides an interactive plotting of lipid regulation statistics based on specific human request; FIG. 4d provides a graph of lipid type vs. number of lipids; FIG. 4e provides a pie-chart showing the number of lipids of each class; FIG. 4f provides a ridge plot of LogFC for each lipid type; and FIG. 4g provides a density plot with multiple lipid types.

FIG. 4h is an example of interaction of when a user requests advice for a leaking LC.

FIG. 4i is an example of interaction of when a user requests advice for a broken LC pump.

FIG. 4j is an example of interaction of when a user requests advice for a leaking column.

FIG. 4k is an example of interaction of when a user requests advice for an LC column not heating.

FIG. 4l is an example of interaction of when a user requests advice for an LC column not heating.

FIG. 4m is an example of interaction of when a user requests information on improvements of the 6490 series over the 6460 series.

FIG. 4n a is an example of interaction of when a user requests definition of a “triggered MRM.”

FIG. 4o is an example of interaction of when a user requests advice for no signal in the mass spectrometer.

FIG. 5 is an example of a processing system that can carry out the processes discussed in the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel system and method are disclosed herein for mass spectrometry tools, such as the automatic worklist generator, to be integrated with Artificially Intelligent (AI) agents for automating lipidomics experiments and analysis. An AI platform can be designed and developed to automate lipidomics experiments and analysis using large language models. Recent advancements in generative AI have ushered in a new era of automation, exploration, and discovery in the chemical sciences. In particular, the enhanced reasoning and generative power of modern large language models (LLMs) has allowed for the creation of AI agents which possess the ability to comprehend and assist human chemists with various laboratory tasks. In this manuscript, we showcase an application of this technology to the field of lipidomics by creating a tailored set of AI agents which assist human chemists with mass spectrometry worklist generation, comparative analysis of samples, statistical inference and plotting, and targeted interaction with literature and documentation. These agents use LLMs to interpret human language and then access software-based tools, documentation embeddings, or code interpreters to robustly fulfill requests. This system of lipidomic AI agents is controlled by an agent manager which uses LLMs to direct requests to the appropriate agent based on the request context. The system was tested on AI guided comparative analysis of lipid droplets from 5×FAD vs Wildtype mice. To our knowledge this is the first example of AI agent technology being applied to the field of mass spectrometry and lipidomics.

These AI agents use contextual knowledge of the tool combined to provide users with informed parameter suggestions. This improves upon current systems that rely solely on user knowledge for parameter input, making the process simpler and more user-friendly. After initiating data acquisition, users often need to stop due to experimental errors such as no signal in the mass spectrometer or solvent leakage. When an error occurs, users commonly consult expert scientists with in-depth knowledge of the experiment and instrumentation. If such expertise is not readily available, users often turn to scientific literature and instrumentation documentation. However, many users resort to search engines because they do not want to read hundreds of pages of technical documentation, even though companies do a good job summarizing their information for troubleshooting specific instruments. Unfortunately, not every laboratory has the advantage of having an expert readily available. Reviewing relevant studies and methods in scientific papers is often a meticulous and tedious process, requiring sifting through vast amounts of data and interpreting complex information. The internet offers a broad spectrum of perspectives and potential solutions, but it demands a discerning eye to separate useful information from less relevant or reliable content. AI agents can be given access to technical documentation of the relevant instrument to assist in experimental design and troubleshooting. They can cite relevant documentation for the user to examine in more depth. AI agents offer an innovative and interactive way to troubleshoot instrument problems while providing information solely from the relevant documentation.

While conducting an experiment is important, accurate and relevant analysis of results is equally paramount. This stage often involves consulting experts and delving into scientific literature for a comprehensive understanding of the results. The lack of access to an expert for guidance and training can result in time-consuming and potentially inaccurate analysis, highlighting the importance of expert involvement in all phases of an experiment. Furthermore, with the advent of automation in experiments, there is a proliferation of vast amounts of data generated. Manually analyzing such large datasets is nearly impossible, necessitating automated assistance. While software has been developed for this purpose, it often requires manual setting of parameters to function effectively. Even then, navigating through extensive data remains a tedious and time-consuming process. Automation of analysis is more straightforward when results are anticipated, but in exploratory studies or when unexpected events occur, these automated systems can fail. AI agents can provide relevant information based on scientific papers to assist in comparative analysis. They can use predefined tools to correctly perform the analysis, format the data for these tools, and discuss the meaning of the results. This integration allows for more accurate and efficient analysis, even in the absence of human experts, ensuring that the data is interpreted correctly and comprehensively.

The scientific community has begun to incorporate machine learning methodology to enhance experimental procedures and data analysis in mass spectrometry experiments. Advancements in computational hardware, new machine learning architectures, and high-throughput systems have caused machine learning to surge in popularity. This surge is evident across various domains such as spectral (pre)processing, spectra analysis for compound identification, sample classification and clinical diagnostics, omics and single-cell mass spectrometry, MSI imaging analysis, and more. This was discussed in depth in our previous review. ²⁸ In our prior work, AI agents were employed for comparative analysis of lipidomics data between 5×FAD and WT mice.²⁷ Our current work advances this concept by introducing the first comprehensive AI-assisted mass spectrometry pipeline utilizing Large Language Models (LLMs) which includes experimental troubleshooting, worklist generation, data parsing/annotation, comparative analysis, and data analysis.

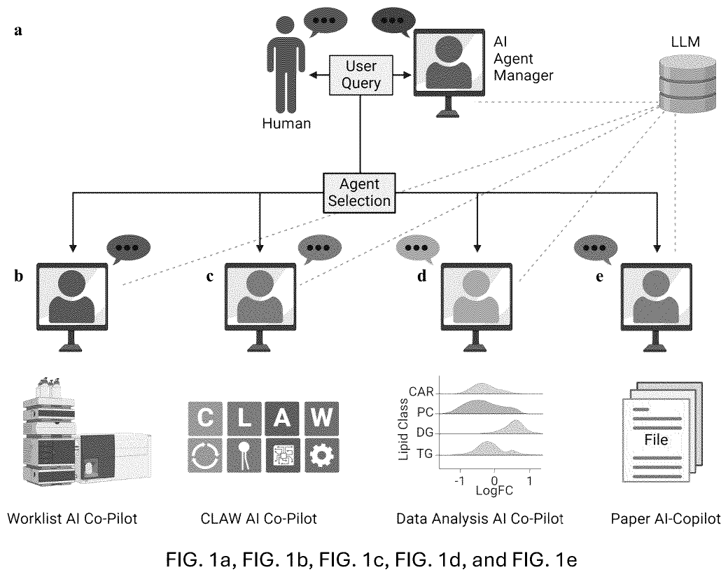

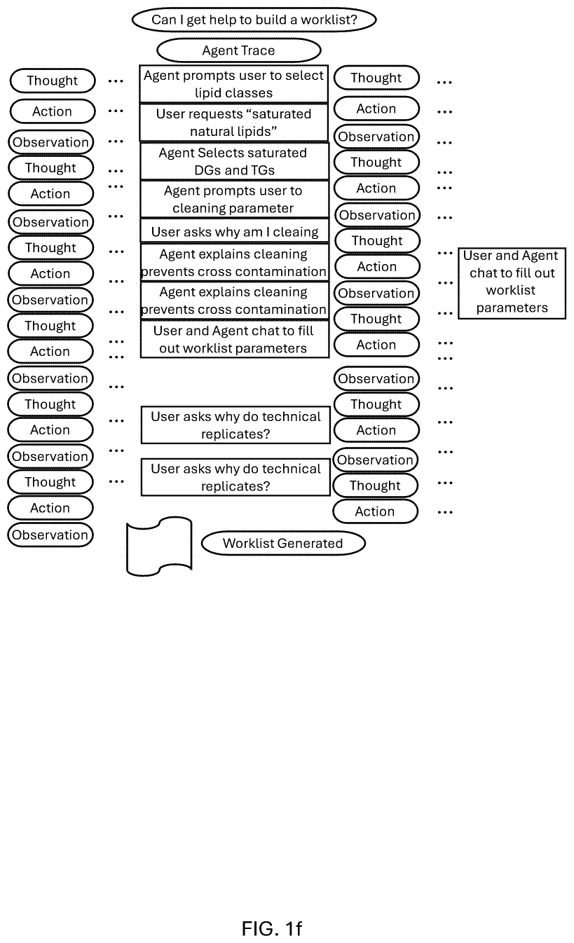

Reference is made to FIGS. 1a-1e, which provide an overview of AI driven lipidomic process, according to the present disclosure. Specifically, AI co-pilot functionality communication flowchart including human to agent and agent to agent communication (FIG. 1a), AI guided MRM worklist generation for Agilent MassHunter software (FIG. 1b), AI assisted comparative analysis of lipidomic samples (FIG. 1c), generalized data analysis and plotting of comparative lipidomic results using cloud-based, sandboxed code environments (FIG. 1d), and AI assisted summarization and citation of instrument documentation (FIG. 1e).

All AI driven experiments were performed on an Agilent 6495C Triple Quadrupole (QQQ) Mass Spectrometer (MS) interfaced with an Agilent 1290 Infinity II LC System. All MRM-based experiments relied on flow injection (i.e., no chromatographic separation). The Agilent LC-MS system is connected to a computer running Windows 10 which uses Agilent software to run the instrument and access results. The LC-MS is controlled by Agilent Mass Hunter Workstation LC/MS Data Acquisition for 6400 Series Triple Quadrupole version 10.0 SR1 build 10.0.142.

AI agents were built to act as user friendly co-pilots for Agilent Mass Hunter worklist generation, MRM data processing using New Comprehensive Lipidomic Automation Workflow (NEW-CLAW or simply CLAW), lipidomic comparative analysis using R, data analysis in E2B cloud hosted environments (version 0.14), and literature and documentation summarization using PaperQA (version 3.13). All AI agents were constructed using LangChain's Python module (version 0.1.0) for large language model (LLM) integrated AI development. All AI agents included the following components: A provided LLM, a set of tools implemented in Python, a detailed prompt, and memory of past interactions. The choice of LLM is generally agnostic in LangChain and left up to the developer to decide. We implemented and tested all AI agents using OpenAI's GPT4 model. (https://Python.langchain.com/docs/get_started/introduction). For any schematic validation we used Pydantic (version 1.10). To see the prompts and file descriptions used for each AI agent construction (see Tables 7-Table 11, provided below).

A Python function was developed to access and edit a Mass Hunter MRM worklist template in a directed manner for the creation of custom worklists based on user specifications. This Python function takes in arguments for the interval between cleans, the total number of cleans, the number of cleans after each lipid class, the number of technical replicates, information on the run, the date the run was taken, and the name of the file to save the run results in. The function then opens a template XML formatted worklist file (. wkl), inserts edits based on the provided input parameters, and then saves the new worklist as a separate. wkl file based on the provided file name. The worklist file can then be loaded into Mass Hunter and run on the QQQ MS.

An LLM integrated (gpt-4) AI agent was created with a custom prompt instructing the agent to assist a human in generating a worklist file and to answer any questions they may have about the information needed to generate a custom worklist or general scientific concepts such as MRM profiling (see FIGS. 1a and 1d). This agent was provided with a tool for custom worklist generation which included the following: The Python function for generating the custom worklist, a description of what the function does and what inputs should be provided, and a Pydantic schema of the function arguments. The schema helps enforce the validity of the inputs the LLM provides to the tool. The AI agent was also provided with LangChain's built-in human tool, which is designed to interact with the human for additional information when needed during an agent's internal iterative operation. (https://Python.langchain.com/docs/get_started/introduction) For example usage see below.

The CLAW contains a Juypter Notebook based graphical user interface (GUI) which is designed to set input parameters to claw such as which samples are blanks or irrelevant to the analysis, such as cleaning solutions. This was replaced by an AI agent which is designed to assist the user in setting these parameters (see FIG. 1 b). A Python function was created which dynamically assigns CLAWs internal parameters and this function was built into a tool for the AI agent. The agent's prompt was constructed to accomplish this task and to provide the user with additional relevant information as needed (i.e. “why do I need to choose a blank?”) Once the agent has all relevant information it needs to process the data and confirms this with the user, the parameters are assigned and CLAW's internal data processing begins.

CLAW is integrated with a suite of statistical tools designed for comparative statistical analysis of MRM data. These tools are designed to be run after data parsing/annotation and include R programming scripts for calculating log fold change between classes, etc. To run these tools for comparative analysis, first parse the data and select the blank. The user can then run comparative analysis. The user will first select groups for comparison. This is done by providing CLAW with JavaScript Object Notation (JSON) files which define the filtration criteria. CLAW already has an AI agent for assisting users in creating JSON filters which is described in detail in the CLAW manuscript. The prompt for the agent is almost entirely the same as published in CLAW with a few minor modifications to improve user friendly interaction.

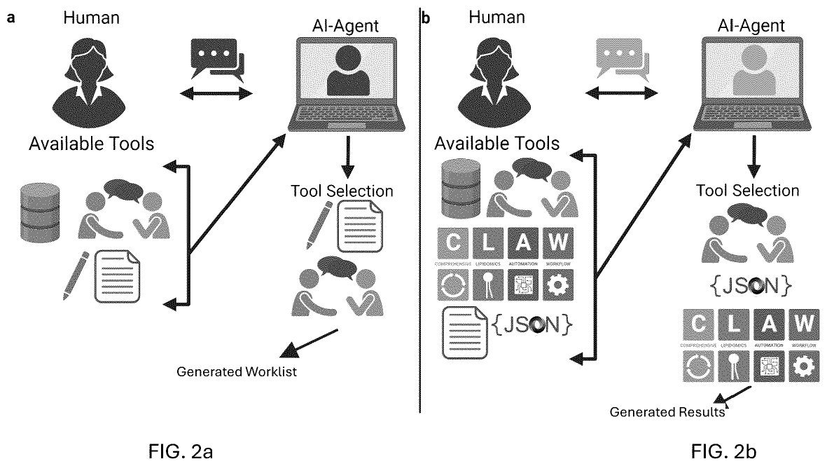

Reference is made to FIG. 2a-2b which provide an overview of AI-driven CLAW process. Specifically, FIG. 2a provides an AI guided MRM worklist generation for Agilent MassHunter software. The user interacts with the AI agent which selects the appropriate tools to generate a worklist. FIG. 2b provides an AI assisted comparative analysis of lipidomic samples. The user chats with the AI agent to select the appropriate tools for AI Driven Data Analysis using E2B Cloud Environments We used E2B's cloud-based environments for sandboxed execution of LLM generated Python code for data analysis of comparative lipidomic results (described herein). This was implemented by integrating an AI agent with LangChain's built-in E2B data analysis tool and providing the agent with the path to and a short description of the data file (see FIG. 1c). (https://Python.langchain.com/docs/get_started/introduction) (https://e2b.dev/blog/build-ai-data-analyst-with-langchain-and-e2b) When prompted by a human to answer questions about provided data, the following process occurs. The AI agent is provided access to the cloud-based environment with a copy of the data file. The agent uses the LLM to interpret the human's request and based on the description of the data file, requests the LLM to generate Python code which can fulfill the human's request. The Python code is then executed in a sandboxed manner in the cloud environment on the data file and the LLM receives any output that is generated. The LLM then analyses the code output and generates a response which is provided to the human as the final answer. E2B cloud environments also allow for humans to request dynamic generation of plots based on provided data. For example usage see below.

We employed PaperQA, an LLM integrated package built using LangChain for summarization of a collection of documents and protocols based on user input query. We set PaperQA to read in all PDF document in a directory defined by the user at a specific environment variable. The PaperQA LLMs were configured with default parameters which uses OpenAI embeddings (text-embedding-ada-002) to embed the documents and a hybrid of GPT 3.5 turbo and GPT 4 to process and summarize retrieved documents. All user questions on technical documentation and guidelines were passed to PaperQA by the managing LLM chain. (https://github.com/whitead/paper-qa), or example see usage section below.

An LLM based agent manager (gpt-4) was constructed to facilitate information transfer from human chemists to individual AI agents. This agent manager essentially acts an LLM facilitated API which identifies endpoints to call based on the contents of the user request. The following endpoints are integrated into the agent manager: Worklist construction, running CLAW, running CLAW comparative analysis, performing data analysis on comparative analysis results using the E2B data analysis package, and QA interaction with instrument and MRM documentation using PaperQA. The agent manager is instructed to refer to domain knowledge for general questions. To create a chatbot style interface, this agent manager is looped iteratively with user input.

In our prior work (see International Patent Application Serial No. PCT/US25/16254, filed Feb. 17, 2025 which is related to and claims the priority benefit of U.S. Provisional Patent Application Ser. No. 63/554,874, filed Feb. 16, 2024, which are both incorporated by reference into the present disclosure) we developed the comprehensive lipidomic automation workflow (CLAW), which contains an automated worklist generator for MRM experiments on the Agilent 6495C QQQ running Agilent Mass Hunter software. The software for this system requires users to populate CSV files, which the program then uses to generate worklists. This method is described in detail in our previous manuscript. The worklist generator functions as a versatile interface to load any relevant method file onto the software, providing a framework that can be readily extended to facilitate other types of mass spectrometry experiments beyond MRM. Our current work integrates an AI agent for user friendly interaction with the worklist generation process. During agent assisted MRM worklist creation the user is required to assign a set of parameters that affect worklist structure including information on which lipid classes to screen, the number of cleaning injections, technical replicates, etc. The agent streamlines the worklist creation process by providing explanations for each variable, ensuring accurate data formatting, and assisting with other questions asked by the user. An example interaction between a human and the automatic worklist generator agent is shown in Table 1, provided below. The user informs the AI agent manager about the desire to generate a worklist. The agent manager selects the agent for worklist generation. In this AI facilitated process for generating a worklist for the Agilent 6495c, the agent guides the user through a series of queries to fill out experiment parameters, ensuring accurate setup for analysis.

Reference is made to Table 1 which provides an Agentic trace of CLAW worklist interaction. The user chats with the AI agent to fill out all the required parameters for worklist generation. In this process, the user interacts with the AI agent to answer questions about the importance of each parameter as well as suggestions of potential values.

TABLE 1
Agentic trace of CLAW worklist interaction

```
Input:
Can I get help to build a worklist?
Sure, I will assist you in generating a worklist.
Agent Trace:
> Entering new AgentExecutor chain...
Thought: The user wants to build a worklist. I need to gather more information to
know what parameters they want to use for the Build Worklist tool. I'll start by
asking about the lipid classes they want to include.
Action:
...
{
  “action”: “human”,
  “action_input”: {
    “query”: “Sure meow, I can help you with that. Which lipid classes would you like
to include in the worklist? You can choose from ‘CAR’, ‘CE’, ‘Cer’, ‘DAG16_0’,
‘DAG16_1’, ‘DAG18_0’, ‘DAG18_1’, ‘DAG18_2’, ‘FA’, ‘PC’, ‘PE’, ‘PG’, ‘PI’, ‘PS’,
‘TAG14_0’, ‘TAG16_0’, ‘TAG16_1’, ‘TAG18_0’, ‘TAG18_1’, ‘TAG18_2’, ‘TAG18_3’,
‘TAG20_4’, ‘TAG22_5’, ‘TAG22_6’. If you have enough sample, we can run all of
them. ”
  }
}
...
Sure meow, I can help you with that. Which lipid classes would you like to include in
the worklist? You can choose from ‘CAR’, ‘CE’, ‘Cer’, ‘DAG16_0’, ‘DAG16_1’,
‘DAG18_0’, ‘DAG18_1’, ‘DAG18_2’, ‘FA’, ‘PC’, ‘PE’, ‘PG’, ‘PI’, ‘PS’, ‘TAG14_0’,
‘TAG16_0’, ‘TAG16_1’, ‘TAG18_0’, ‘TAG18_1’, ‘TAG18_2’, ‘TAG18_3’, ‘TAG20_4’,
‘TAG22_5’, ‘TAG22_6’. If you have enough sample, we can run all of them.
  I would like all the saturated neutral lipids
Observation: I would like all the saturated neutral lipids
Thought:The user wants to include all saturated neutral lipids in the worklist. This
means we should include ‘DAG16_0’, ‘DAG18_0’, ‘TAG14_0’, ‘TAG16_0’,
‘TAG18_0’ in the lipid classes. Now, I'll ask about the cleaning frequency, which is
the number of injections after which the system will be cleaned.
Action:
...
{
  “action”: “human”,
  “action_input”: {
    “query”: “Perfect choice, meow. Now, after how many injections should the
system be cleaned? The default is after every 4 injections. Would you like to use the
default or specify a different value? ”
  }
}
...
Perfect choice, meow. Now, after how many injections should the system be
cleaned? The default is after every 4 injections. Would you like to use the default or
specify a different value?
  why am I cleaning?
Observation: why am I cleaning?
Thought:The user is asking why cleaning is necessary. Cleaning is important to
maintain the quality of the results and prevent contamination. I'll explain this to the
user.
Action:
...
{
  “action”: “human”,
  “action_input”: {
    “query”: “Great question, meow! Cleaning is crucial to prevent contamination and
ensure the quality of your results. Over time, residues from samples can build up and
affect the performance of the system. This could lead to inaccurate results. So,
regular cleaning is a good practice. Now, how often would you like the system to be
cleaned? The default is every 4 injections.”
  }
}
...
Great question, meow! Cleaning is crucial to prevent contamination and ensure the
quality of your results. Over time, residues from samples can build up and affect the
performance of the system. This could lead to inaccurate results. So, regular cleaning
is a good practice. Now, how often would you like the system to be cleaned? The
default is every 4 injections.
  ok lets use that default
Observation: ok lets use that default
Thought:The user agreed to use the default cleaning frequency, which is after every 4
injections. Now, I need to ask about the number of cleaning cycles to be performed
when cleaning is done. This is represented by ‘n_cleans’ in the Build Worklist tool.
Action:
...
{
  “action”: “human”,
  “action_input”: {
    “query”: “Purrfect, we'll clean after every 4 injections. Meow, how many cleaning
cycles would you like to perform when cleaning is done? The default is 2 cycles.
Would you like to use the default or specify a different number? ”
  }
}
...
Purrfect, we'll clean after every 4 injections. Meow, how many cleaning cycles
would you like to perform when cleaning is done? The default is 2 cycles. Would
you like to use the default or specify a different number?
  2
Observation: 2
Thought:The user has specified that they want 2 cleaning cycles, which is also the
default value. Next, I need to ask about the number of technical replicates they want,
which is the number of repeat injections of the same sample.
Action:
...
{
  “action”: “human”,
  “action_input”: {
    “query”: “Great, we'll do 2 cleaning cycles, meow. Now, how many repeat
injections of the same sample would you like? This is also known as technical
replicates. The default is 1 replicate. Would you like to use the default or specify a
different number? ”
  }
}
...
Great, we'll do 2 cleaning cycles, meow. Now, how many repeat injections of the
same sample would you like? This is also known as technical replicates. The default
is 1 replicate. Would you like to use the default or specify a different number?
  why do technical replicates?
Observation: why do technical replicates?
Thought:The user is curious about the purpose of technical replicates. Technical
replicates are repeat injections of the same sample. They are used to assess the
precision of the experiment and help us understand the level of variation within the
experiment itself. I'll explain this to the user.
Action:
...
{
  “action”: “human”,
  “action_input”: {
    “query”: “Good question, meow! Technical replicates are repeat injections of the
same sample. They help us assess the precision of the experiment and understand the
level of variation within the experiment itself. This can be really helpful in ensuring
the reliability of your results. Now, how many technical replicates would you like?
The default is 1 replicate.”
  }
}
...
Good question, meow! Technical replicates are repeat injections of the same sample.
They help us assess the precision of the experiment and understand the level of
variation within the experiment itself. This can be really helpful in ensuring the
reliability of your results. Now, how many technical replicates would you like? The
default is 1 replicate.
  ok lets do 1
Observation: ok lets do 1
Thought:The user has agreed to use the default number of technical replicates, which
is 1. Now, I need to ask about the number of cleans after every lipid class. This is
represented by ‘n_cleans_after_lipid_class’ in the Build Worklist tool.
Action:
...
{
  “action”: “human”,
  “action_input”: {
    “query”: “Splendid choice, meow! Now, how many cleans would you like after
every lipid class? The default is 2 cleans. Would you like to use the default or specify
a different number? ”
  }
}
...
Splendid choice, meow! Now, how many cleans would you like after every lipid
class? The default is 2 cleans. Would you like to use the default or specify a different
number?
  2
Observation: 2
Thought:The user has agreed to use the default number of cleans after every lipid
class, which is 2. Now, I need to ask about the run information they want to include
in the data file. This is represented by ‘run_information’ in the Build Worklist tool.
Action:
...
{
  “action”: “human”,
  “action_input”: {
    “query”: “Alright, we'll do 2 cleans after every lipid class, meow! Now, what run
information would you like to include in the data file? This is just a string saved to
the data file to make it easy to know what data was created. The default is ‘DEMO’.
Would you like to use the default or specify something else? ”
  }
}
...
Alright, we'll do 2 cleans after every lipid class, meow! Now, what run information
would you like to include in the data file? This is just a string saved to the data file to
make it easy to know what data was created. The default is ‘DEMO’. Would you like
to use the default or specify something else?
  lets do DEMO
Observation: lets do DEMO
Thought:The user has agreed to use the default run information, which is ‘DEMO’.
Now, I need to ask about the date they plan to run the sample. This is represented by
‘date_taken’ in the Build Worklist tool.
Action:
...
{
  “action”: “human”,
  “action_input”: {
    “query”: “Got it, we'll use ‘DEMO’ as the run information, meow! Now, when do
you plan to run the sample? Please provide the date in the format of ‘3_3_24’. ”
  }
}
...
Got it, we'll use ‘DEMO’ as the run information, meow! Now, when do you plan to
run the sample? Please provide the date in the format of ‘3_3_24’.
  2_20_24
Observation: 2_20_24
Thought:The user plans to run the sample on 2_20_24. The only thing left to ask is
about the file name they want to save the worklist as. This is represented by
‘file_name_2_save’ in the Build Worklist tool.
Action:
...
{
  “action”: “human”,
  “action_input”: {
    “query”: “Noted, you plan to run the sample on 2_20_24, meow! Finally, under
what file name would you like to save the worklist? Please provide the name without
an extension. The default is ‘DEMO_worklist’. Would you like to use the default or
specify a different name?”
  }
}
...
Noted, you plan to run the sample on 2_20_24, meow! Finally, under what file name
would you like to save the worklist? Please provide the name without an extension.
The default is ‘DEMO_worklist’. Would you like to use the default or specify a
different name?
  DEMO_worklist
Observation: DEMO_worklist
Thought:The user has agreed to use the default file name, which is ‘DEMO_worklist’.
Now, I need to ask about the cleaning solution position. This is represented by
‘clean_solution_position’ in the Build Worklist tool.
Action:
...
{
  “action”: “human”,
  “action_input”: {
    “query”: “Alright, we'll save the worklist as ‘DEMO_worklist’, meow! Lastly,
where is the cleaning solution located? The default position is ‘p1-al’. Would you
like to use the default or specify a different position? ”
  }
}
...
Alright, we'll save the worklist as ‘DEMO_worklist’, meow! Lastly, where is the
cleaning solution located? The default position is ‘p1-a1’. Would you like to use the
default or specify a different position?
  p1-a1
Observation: p1-a1
Thought:The user has agreed to use the default cleaning solution position, which is
‘p1-a1’. Now that I have all the necessary parameters, I can use the Build Worklist
tool to generate the worklist.
Action:
...
{
  “action”: “Build Worklist”,
  “action_input”: {
    “lipid_classes”: [“DAG16_0”, “DAG18_0”, “TAG14_0”, “TAG16_0”,
“TAG18_0”],
    “clean_every_n”: 4,
    “n_cleans”: 2,
    “n_cleans_after_lipid_class”: 2,
    “technical_replicates”: 1,
    “run_information”: “DEMO”,
    “date_taken”: “2_20_24”,
    “file_name_2_save”: “DEMO_worklist”,
    “clean_solution_position”: “p1-a1”
  }
}
...
Observation: None
Thought:Now that we have built the worklist using the Build Worklist tool, the next
step is to inform the user that the worklist has been successfully created and is ready
for use.
Action:
...
...
> Finished chain.
Purrfect! Your worklist has been built successfully and saved as ‘DEMO_worklist’. It
includes all saturated neutral lipids and will be run on ‘2_20_24’. The system will
clean after every 4 injections and perform 2 cleaning cycles when cleaning is done.
After every lipid class, 2 cleans will be performed. We will have 1 technical replicate
of the same sample. You must be kitten me right meow, we did a good job!
```

Reference is also made to FIG. 1f which provides an example of an agentic trace of CLAW worklist interaction. The user chats with the AI agent to fill out all the required parameters for worklist generation. In this process, the user interacts with the AI agent to answer questions about the importance of each parameter as well as suggestions of potential values.

Initially, the worklist generation agent asks which lipid classes the user intends to analyze in the experiment. The user specifies the desire to include “. . . all saturated neutral lipids.” When interpreting this, the AI agent determines that the appropriate classes to run are all triacylglycerols (TG) and diacylglycerols (DG) lipid types with saturated fatty acid (FA) chains. The prompt provided to this agent did not include this information about lipid classes, saturation, or charge or any tools which can access external information about these topics. This showcases the ability of the agent to use the integrated LLM's domain of knowledge to take a general user request and translate it to a more specific request targeted to the task at hand. Next, the agent suggests a default cleaning frequency of every four samples. The user asks about the necessity of the cleaning step, prompting the AI to say “. . . Cleaning is crucial to prevent contamination and ensure the quality of your results. Over time, residues from samples can build up and affect the performance of the system. This could lead to inaccurate results. . .” his showcases the ability of the agent to give specific answers in the context of mass spectrometry experiments instead of general information on a broad topic such as cleaning which may not be relevant to the task at hand. The interaction is shown in Table 1 and FIG. 1f.

Next, the user then provides additional cleaning parameters as prompted by the agent. When asked to select the number of technical replicates the user inquirers about their importance. The agent explains that technical replicates are repeated injections of the same sample and that they are used to evaluate the experiment's variability. The agent also provides the default value for this parameter and the user chooses one replication as shown in Table 1 and FIG. 1f. This interaction further demonstrates that the agent's answers are specific to a mass spectrometry experiment. Finally, the user requests default conditions for the number of cleans after each lipid class, run information, the date of the run, the worklist file name, and confirms the default cleaning solution position as ‘p1-a1’. This information is used to differentiate between runs, but the default values can always be used. This seamless interaction showcases the ability of AI to make mass spectrometry experiment setup efficient and user friendly by explaining procedures, inferring user inputs like the need for neutral lipids, and guiding the selection of appropriate parameters for tools used in worklist creation. The entire interaction is provided in Table 1 and FIG. 1f.

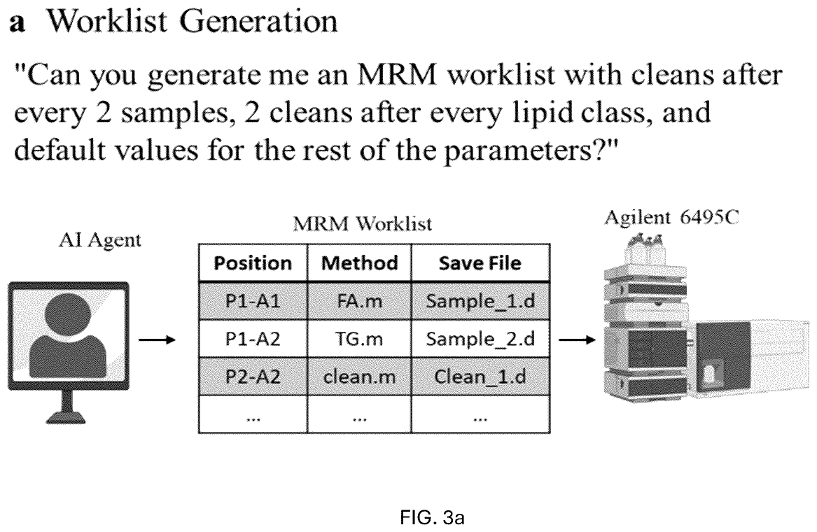

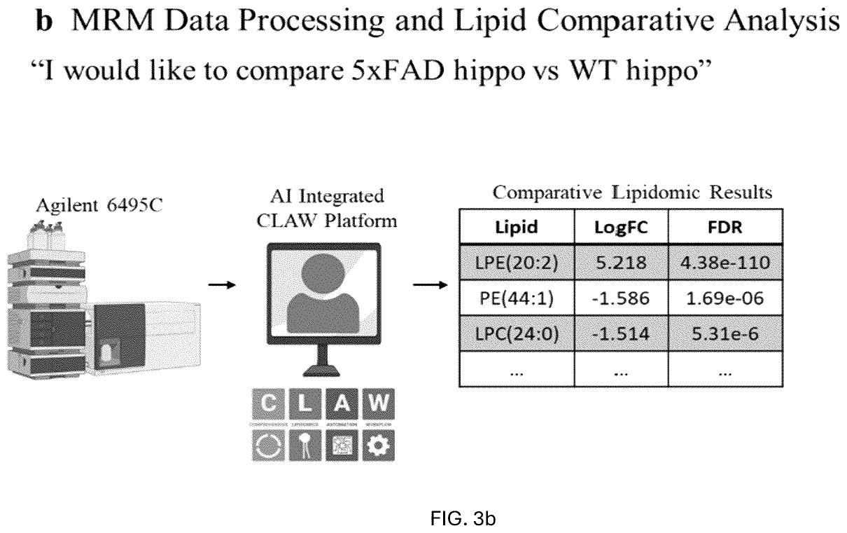

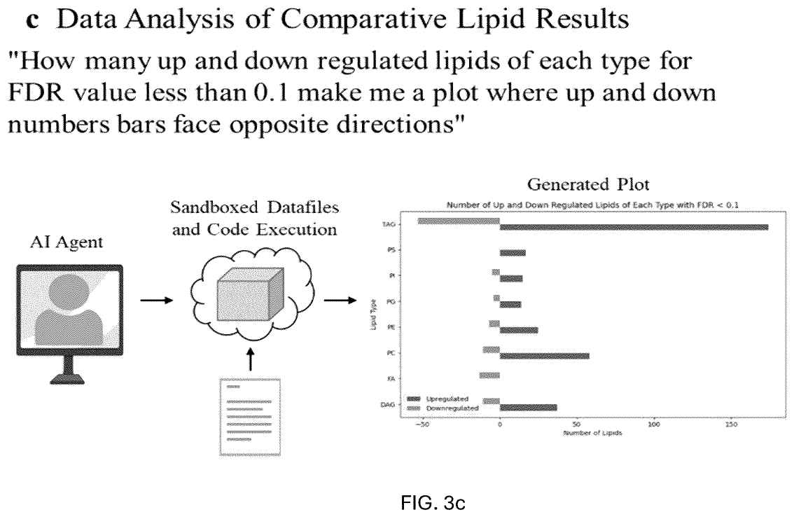

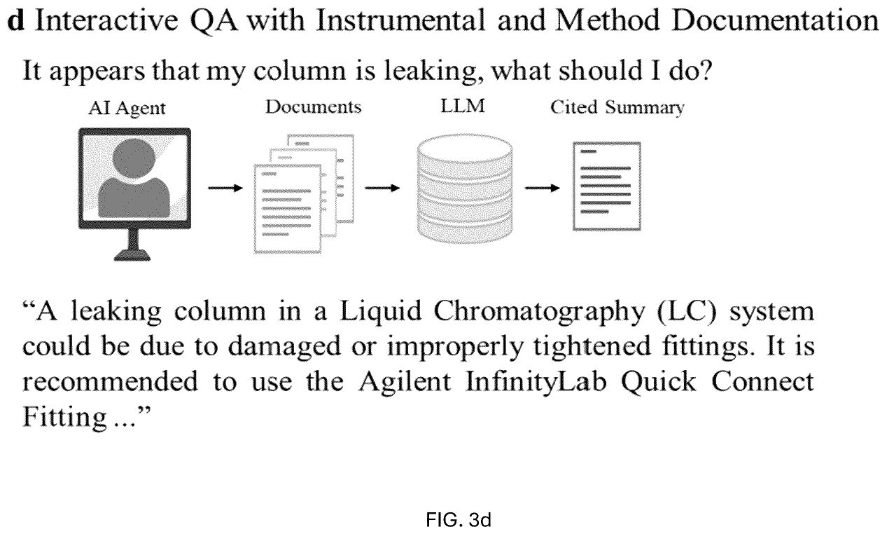

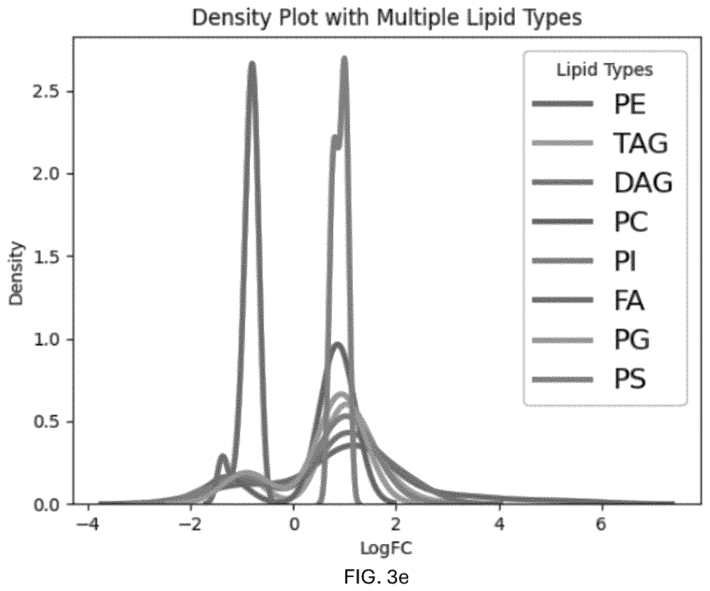

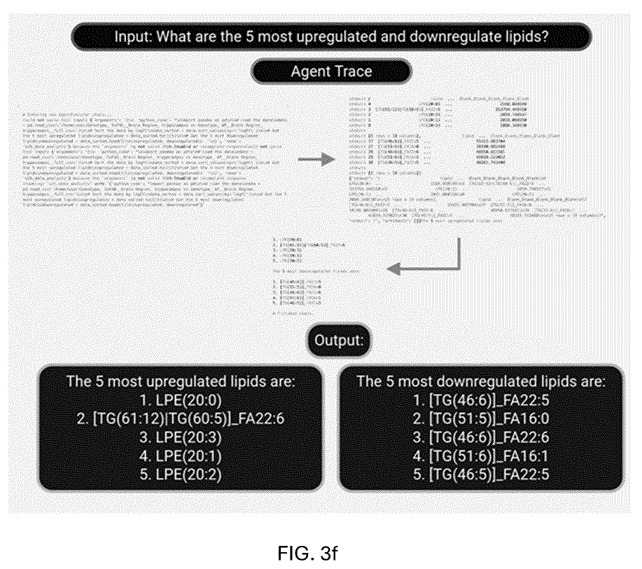

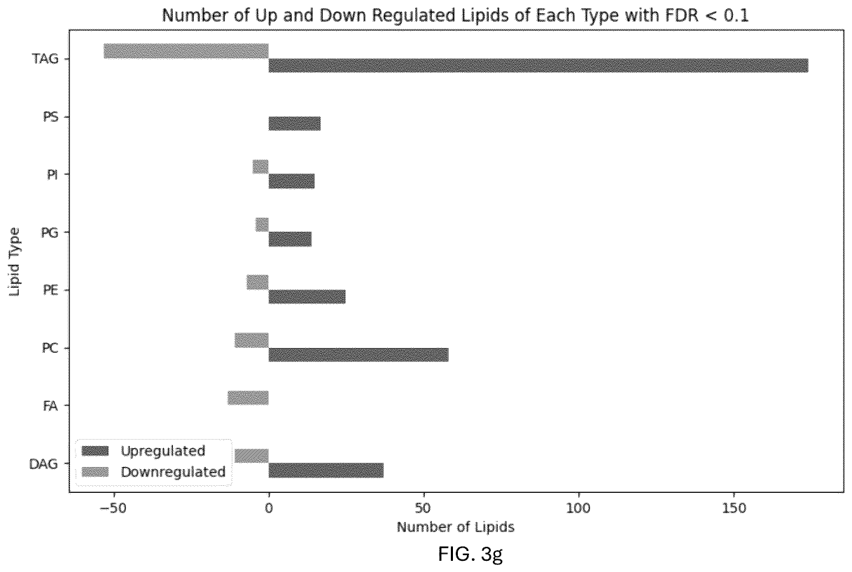

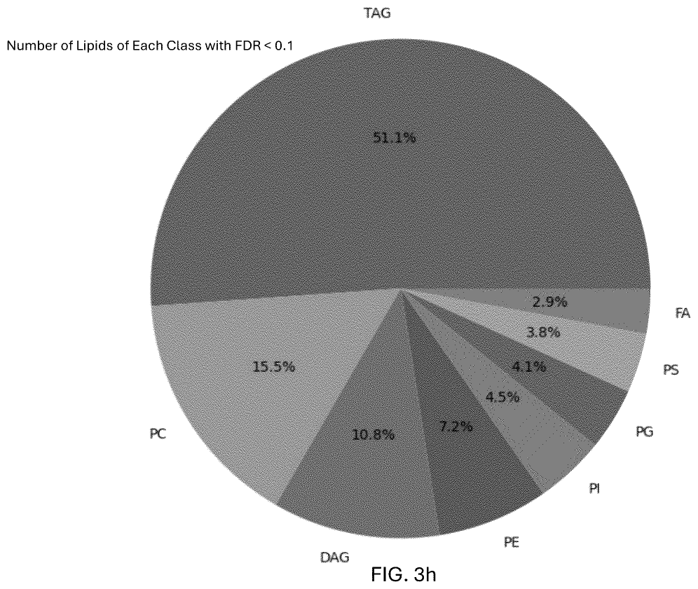

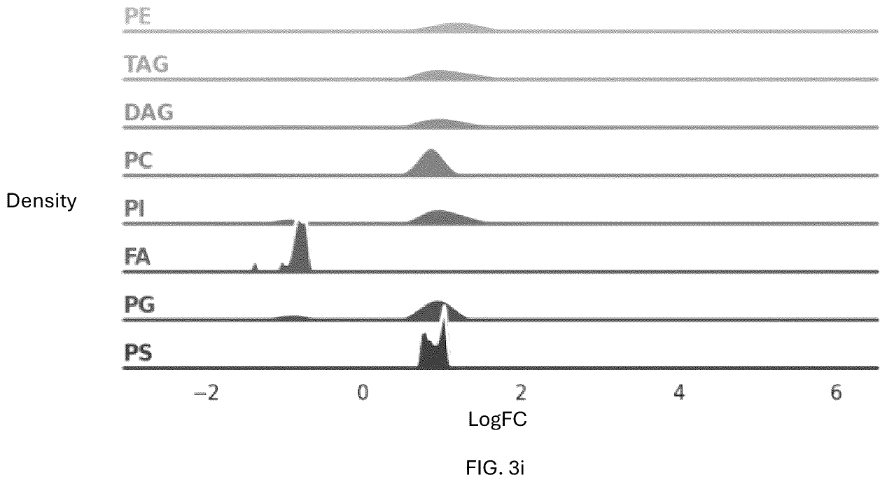

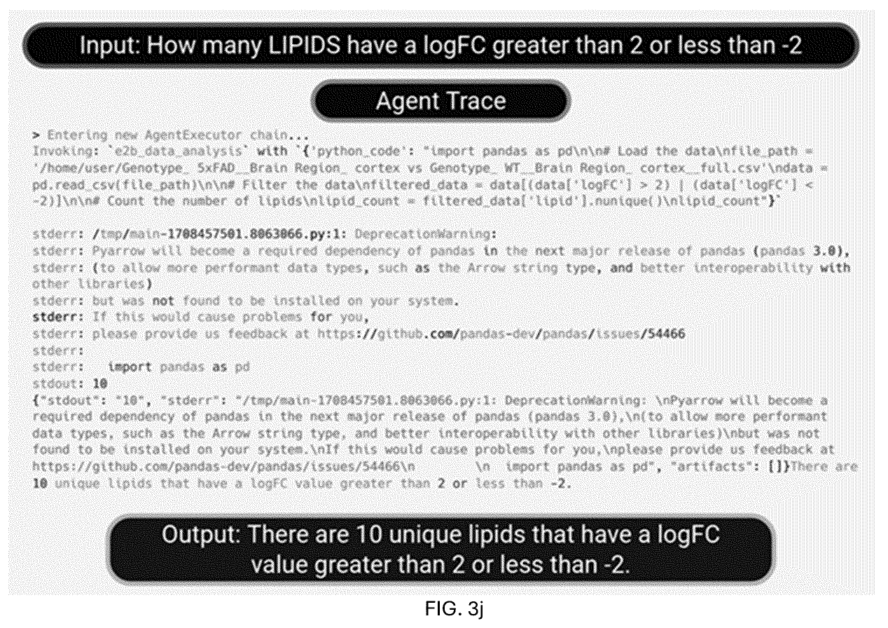

Reference is made to FIGS. 3a-3d which provide a short overview demonstrating the capabilities of the AI agents for automating lipidomics experiments and analysis using large language models. Specifically, FIG. 3a provides an AI guided MRM worklist generation for Agilent MassHunter software. FIG. 3b provides an AI assisted comparative analysis of lipidomic samples. FIG. 3c provides a generalized data analysis and plotting of comparative lipidomic results using cloud-based, sandboxed code environments. FIG. 3d provides a schematic of specific instrument documentation and method development.

Following the generation of worklists and the collection of experimental data, the user can parse, annotate, and conduct statistical analyses on chosen groups by asking the manager agent to run CLAW. The AI-copilot will automatically attempt to identify potential blanks within the provided sample and exclude irrelevant data, such as cleaning solutions. Blanks are integral to our statistical models as they enable the determination of the background level of the instrument, which is crucial for accurate analysis. While filtering out irrelevant data like cleaning solutions is not strictly necessary, it streamlines the process by reducing the clutter in the dataset, thereby minimizing the options presented to users when selecting groups for comparative analysis and enhancing the efficiency and clarity of the analysis. The AI agent will then seek user confirmation on these selections. An example of the full interaction is provided in Table 1, which is provided below. After data parsing is complete the user will be redirected to the AI agent manager.

Reference is made to Table 1 which provides an example of an agentic trace of agent running CLAW. The user runs the CLAW software via the AI agent by selecting the groups for statistical analysis. During this process, the user is able to get detailed information from the AI agent about the groups available for comparative analysis and how they relate to Alzheimer's disease.

TABLE 1
Agentic Execution of CLAW for Comparative Analysis of 5xFAD and WT Mice

```
Input:
ok lets now run Claw
Alright, let's get Claw running for you.
Agent Trace:
> Entering new AgentExecutor chain...
Thought: The first step in finding the blank is to access the list of unique samples. I will
use the return_sample_tool to get this list.
Action:
‘‘‘
{
  ″action″: ″return_sample_tool″,
  ″action_input″: { }
}
‘‘‘
Observation: [′Blank_Blank_Blank_Blank_Blank′, ′IPA_clean_clean_clean_clean′,
′DOD94_F3_Female_WT_hippocampus′, ′DOD94_F3_Female_WT_cortex ′,
′DOD94_F3_Female_WT_cerebellum′, ′DOD94_F3_Female_WT_diencephalon′,
′DOD93_F4_Female_5xFAD_hippocampus′, ′DOD93_F4_Female_5xFAD_cortex ′,
′DOD93_F4_Female_5xFAD_cerebellum′, ′DOD93_F4_Female_5xFAD_diencephalon′,
′DOD94_F4_Female_5xFAD_hippocampus′, ′DOD94_F4_Female_5xFAD_cortex ′,
′DOD94_F4_Female_5xFAD_cerebellum′, ′DOD94_F4_Female_5xFAD_diencephalon′,
′FAD185_M4_Male_WT_hippocampus′, ′FAD185_M4_Male_WT_cortex ′,
′FAD185_M4_Male_WT_cerebellum′, ′FAD185_M4_Male_WT_diencephalon′,
′FAD184_F3_Female_WT_hippocampus′, ′FAD184_F3_Female_WT_cortex ′,
′FAD184_F3_Female_WT_cerebellum′, ′FAD184_F3_Female_WT_diencephalon′,
′FAD184_F4_Female_WT_hippocampus′, ′FAD184_F4_Female_WT_cortex ′,
′FAD184_F4_Female_WT_cerebellum′, ′FAD184_F4_Female_WT_diencephalon′,
′FAD189_M3_Male_WT_hippocampus′, ′FAD189_M3_Male_WT_cortex ′,
′FAD189_M3_Male_WT_cerebellum′, ′FAD189_M3_Male_WT_diencephalon′,
′FAD189_M2_Male_5xFAD_hippocampus′, ′FAD189_M2_Male_5xFAD_cortex ′,
′FAD189_M2_Male_5xFAD_cerebellum′, ′FAD189_M2_Male_5xFAD_diencephalon′,
′FAD189_M1_Male_5xFAD_hippocampus′, ′FAD189_M1_Male_5xFAD_cortex ′,
′FAD189_M1_Male_5xFAD_cerebellum′, ′FAD189_M1_Male_5xFAD_diencephalon′,
′FAD185_M3_Male_5xFAD_hippocampus′, ′FAD185_M3_Male_5xFAD_cortex ′,
′FAD185_M3_Male_5xFAD_cerebellum′, ′FAD185_M3_Male_5xFAD_diencephalon′,
′FAD185_M1_Male_5xFAD_hippocampus′, ′FAD185_M1_Male_5xFAD_cortex ′,
′FAD185_M1_Male_5xFAD_cerebellum′, ′FAD185_M1_Male_5xFAD_diencephalon′,
′SPLASH_splash_splash_splash_splash′]
Thought:Looking at the list, I notice there's a sample with the name
′Blank_Blank_Blank_Blank_Blank′. This seems to be the most suitable for a blank
variable. However, I should confirm this with the user. Let's ask the user to confirm if
this is the correct blank variable to use or if there is another they would prefer.
Action:
‘‘‘
{
  ″action″: ″human″,
  ″action_input″: {″query″: ″I noticed ′Blank_Blank_Blank_Blank_Blank′ in the list of
samples. Should I use this as the blank variable or is there another you would prefer?″}
}
‘‘‘
I noticed ′Blank_Blank_Blank_Blank_Blank′ in the list of samples. Should I use this as
the blank variable or is there another you would prefer?
  no thats good.
Observation: no thats good.
Thought:The user confirmed that ′Blank_Blank_Blank_Blank_Blank′ is the appropriate
blank variable. Now, I need to define this variable using the define_variables tool.
Action:
‘‘‘
{
  ″action″: ″define_variables″,
  ″action_input″: {″blank_name″: ″Blank_Blank_Blank_Blank_Blank″}
}
‘‘‘
Observation: Successfully Assigned Blank Name to Blank_Blank_Blank_Blank_Blank
Thought:Now that we've got the blank variable sorted out, it's time to write a list of
samples that we need to filter out. Looking at the list, I see
′IPA_clean_clean_clean_clean′ and ′SPLASH_splash_splash_splash_splash′ which might
be non-scientific samples. However, I should confirm this with the user. Time to pose
another question.
Action:
‘‘‘
{
  ″action″: ″human″,
  ″action_input″: {″query″: ″I noticed ′IPA_clean_clean_clean_clean′ and
′SPLASH_splash_splash_splash_splash′ in the list. Should I filter these samples out or is
there any other sample you would like to add to the filter list?″}
}
‘‘‘
I noticed ′IPA_clean_clean_clean_clean′ and ′SPLASH_splash_splash_splash_splash′ in
the list. Should I filter these samples out or is there any other sample you would like to
add to the filter list?
  yes those are good
Observation: yes those are good
Thought:The user has confirmed that ′IPA_clean_clean_clean_clean′ and
′SPLASH_splash_splash_splash_splash′ are samples to be filtered out. I will now use the
write_to_filter_csv_tool to write these samples to the filter list.
Action:
‘‘‘
{
  ″action″: ″write_to_filter_csv_tool″,
  ″action_input″: {″list_to_filter″: [″IPA_clean_clean_clean_clean″,
″SPLASH_splash_splash_splash_splash″]}
}
‘‘‘
Observation: None
Thought:With the filter list written and the blank variable defined, we've accomplished
what we set out to do. Now it's time to report back to the user.
Action:
‘‘‘
{
  ″action″: ″Final Answer″,
  ″action_input″: ″The blank variable has been successfully defined as
′Blank_Blank_Blank_Blank_Blank′. Also, the samples ′IPA_clean_clean_clean_clean′
and ′SPLASH_splash_splash_splash_splash′ have been added to the filter list.″
}
‘‘‘
> Finished chain.
None
  ok lets do comparative analysis
Alright, let's proceed with comparative analysis.
> Entering new AgentExecutor chain...
Thought: Since I need to do a comparative analysis, I need to filter the JSON into two
separate groups. But first, I need to know what keys are in the JSON.
Action: json_spec_list_keys
Action Input: data
Observation: [′Cage′, ′Sex′, ′Genotype′, ′Brain Region′]
Thought:Meow! There are four keys in the data: ′Cage′, ′Sex′, ′Genotype′, and ′Brain
Region′. Let′s ask the human which two they′d like to filter on for their comparative
analysis.
Action: Human
Action Input: Meow! Here are the keys in your data: ′Cage′, ′Sex′, ′Genotype′, and ′Brain
Region′. Which two would you like to use for your comparative analysis, human?
Observation: Human is not a valid tool, try one of [json_spec_list_keys,
json_spec_get_value, json_filter_json_from_lists, human, write_file].
Thought:Oops, seems like there was a mistake. I need to use the ′human′ tool in
lowercase. Let's try again.
Action: human
Action Input: Meow! Here are the keys in your data: ′Cage′, ′Sex′, ′Genotype′, and ′Brain
Region′. Which two would you like to use for your comparative analysis, human?
Meow! Here are the keys in your data: ′Cage′, ′Sex′, ′Genotype′, and ′Brain Region′.
Which two would you like to use for your comparative analysis, human?
  please explain what genotype options are and what they mean also explain what brain
region options I have and please mention how each of these relate to Alzheimer's disease.
Observation: please explain what genotype options are and what they mean also explain
what brain region options I have and please mention how each of these relate to
Alzheimer's disease.
Thought:Meow! Human wants to know the possible values for the ′Genotype′ and ′Brain
Region′ keys and how they relate to Alzheimer's disease. First, let's find out the possible
values for the ′Genotype′ key.
Action: json_spec_get_value
Action Input: data[″Genotype″]
Observation: [′Blank′, ′WT′, ′5xFAD′]
Thought:Meow! The ′Genotype′ key has three possible values: ′Blank′, ′WT′, and
′5xFAD′. ′WT′ stands for ′Wild Type′, which is the standard or typical form of an
organism or gene. ′5xFAD′ is a transgenic mouse model of Alzheimer's disease, carrying
five familial Alzheimer's disease mutations. Now let's find out the values for the ′Brain
Region′ key.
Action: json_spec_get_value
Action Input: data[″Brain Region″]
Observation: [′Blank′, ′hippocampus′, ′cortex′, ′cerebellum′, ′diencephalon′]
Thought:Meow! The ′Brain Region′ key has five possible values: ′Blank′, ′hippocampus′,
′cortex′, ′cerebellum′, and ′diencephalon′. The hippocampus and cortex are particularly
relevant to Alzheimer′s disease as these areas of the brain are often affected in the early
stages of the disease. Now, let′s provide this information to the human.
Action: human
Action Input: Meow! The ′Genotype′ key has three possible values: ′Blank′, ′WT′ (Wild
Type), and ′5xFAD′. The ′5xFAD′ is a mouse model of Alzheimer′s disease, carrying five
familial Alzheimer′s disease mutations. The ′Brain Region′ key has five possible values:
′Blank′, ′hippocampus′, ′cortex′, ′cerebellum′, and ′diencephalon′. The hippocampus and
cortex are key regions affected in Alzheimer′s disease. Which values would you like to
use for your comparative analysis, human?
Meow! The ′Genotype′ key has three possible values: ′Blank′, ′WT′ (Wild Type), and
′5xFAD′. The ′5xFAD′ is a mouse model of Alzheimer′s disease, carrying five familial
Alzheimer′s disease mutations. The ′Brain Region′ key has five possible values: ′Blank′,
′hippocampus′, ′cortex′, ′cerebellum′, and ′diencephalon′. The hippocampus and cortex are
key regions affected in Alzheimer′s disease. Which values would you like to use for your
comparative analysis, human?
  ok lets do 5xFAD hippo vs WT hippo
Observation: ok lets do 5xFAD hippo vs WT hippo
Thought:The human wants to compare ′5xFAD′ and ′WT′ for the ′Genotype′ key and
′hippocampus′ for the ′Brain Region′ key. I should filter the JSON based on these values.
Let′s start with ′5xFAD′ and ′hippocampus′.
Action: json_filter_json_from_lists
Action Input: [″Genotype″, ″Brain Region″];[″5xFAD″, ″hippocampus″]
Observation: {′Genotype′: [′5xFAD′], ′Brain Region′: [′hippocampus′]}
Thought:Meow! The JSON has been successfully filtered with ′5xFAD′ for ′Genotype′
and ′hippocampus′ for ′Brain Region′. Let's confirm this with the human before we write
the file.
Action: human
Action Input: Meow! Here's the filtered data for ′5xFAD′ and ′hippocampus′: {′Genotype′:
[′5xFAD′], ′Brain Region′: [′hippocampus′]}. Is this what you wanted, human?
Meow! Here′s the filtered data for ′5xFAD′ and ′hippocampus′: {′Genotype′: [′5xFAD′],
′Brain Region′: [′hippocampus′]}. Is this what you wanted, human?
  yes
Observation: yes
Thought:The human has confirmed the filtered data. Now, I should write this filtered
JSON to the first file.
Action: write_file
Action Input: {″path″:
″/scratch/gilbreth/cbeveri/Scholar_HOME/Scholar_HOME_orig/Scholar_HOME_1/
Agilent_6495_QQQ_LLM/DEMO/demo_data/JSON/filter_keys_1.json″, ″text″:
″{\″Genotype\″: [\″5xFAD\″], \″Brain Region\″: [\″hippocampus\″]}″}
Observation: File written successfully to
/scratch/gilbreth/cbeveri/Scholar_HOME/Scholar_HOME_orig/Scholar_HOME_1/
Agilent_6495_QQQ_LLM/DEMO/demo_data/JSON/filter_keys_1.json.
Thought:Meow! The first filtered JSON has been successfully written to the file. Now,
let's filter the JSON for ′WT′ and ′hippocampus′.
Action: json_filter_json_from_lists
Action Input: [″Genotype″, ″Brain Region″];[″WT″, ″hippocampus″]
Observation: {′Genotype′: [′WT′], ′Brain Region′: [′hippocampus′]}
Thought:Meow! The JSON has been successfully filtered with ′WT′ for ′Genotype′ and
′hippocampus′ for ′Brain Region′. Let's confirm this with the human before we write the
file.
Action: human
Action Input: Meow! Here′s the filtered data for ′WT′ and ′hippocampus′: {′Genotype′:
[′WT′], ′Brain Region′: [′hippocampus′]}. Is this what you wanted, human?
Meow! Here′s the filtered data for ′WT′ and ′hippocampus′: {′Genotype′: [′WT′], ′Brain
Region′: [′hippocampus′]}. Is this what you wanted, human?
  ya
Observation: ya
Thought:The human has confirmed the filtered data. Now, I should write this filtered
JSON to the second file.
Action: write_file
Action Input: {″path″:
″/scratch/gilbreth/cbeveri/Scholar_HOME/Scholar_HOME_orig/Scholar_HOME_1/
Agilent_6495_QQQ_LLM/DEMO/demo_data/JSON/filter_keys_2.json″, ″text″:
″{\″Genotype\″: [\″WT\″], \″Brain Region\″: [\″hippocampus\″]}″}
Observation: File written successfully to
/scratch/gilbreth/cbeveri/Scholar_HOME/Scholar_HOME_orig/Scholar_HOME_1/
Agilent_6495_QQQ_LLM/DEMO/demo_data/JSON/filter_keys_2.json.
Thought:Meow! Both filtered JSONs have been successfully written to the files. I'm all
done here.
Final Answer: Meow! I've filtered the data and written two JSONs. The first JSON has
data for ′5xFAD′ genotype and ′hippocampus′ brain region. The second JSON has data for
′WT′ genotype and ′hippocampus′ brain region. The files are located at
/scratch/gilbreth/cbeveri/Scholar_HOME/Scholar_HOME_orig/Scholar_HOME_1/
Agilent_6495_QQQ_LLM/DEMO/demo_data/JSON/filter_keys_1.json and
/scratch/gilbreth/cbeveri/Scholar_HOME/Scholar_HOME_orig/Scholar_HOME_1/
Agilent_6495_QQQ_LLM/DEMO/demo_data/JSON/filter_keys_2.json.
> Finished chain.
myjob.sh: line 3: $′\r′: command not found
Lmod is automatically replacing ″intel/17.0.1.132″ with ″gcc/6.3.0.″
Inactive Modules:
  1) impi/2017.1.132
myjob.sh: line 5: $′\r′: command not found
R version 4.1.2 (2021-11-01) -- ″Bird Hippie″
Copyright (C) 2021 The R Foundation for Statistical Computing
Platform: x86_64-pc-linux-gnu (64-bit)
R is free software and comes with ABSOLUTELY NO WARRANTY.
You are welcome to redistribute it under certain conditions.
Type ′license( )′ or ′license( )′ for distribution details.
  Natural language support but running in an English locale
R is a collaborative project with many contributors.
Type ′contributors( )′ for more information and
′citation( )′ on how to cite R or R packages in publications.
Type ′demo( )′ for some demos, ′help( )′ for on-line help, or
′help.start( )′ for an HTML browser interface to help.
Type ′q( )′ to quit R.
> # # Function to check and install packages
> # install_if_not_installed <− function(package_name) {
> # if (!require(package_name, character.only = TRUE)) {
> # install.packages(package_name, dependencies = TRUE)
> # }
> # }
...
>
> library(plyr)
> library(ggridges)
> library(tidyverse)
Output is truncated. View as a scrollable element or open in a text editor. Adjust cell
output settings...
---- Attaching core tidyverse packages
tidyverse 2.0.0 ----
✓ dplyr 1.1.4 ✓ readr 2.1.4
✓ forcats 1.0.0 ✓ stringr 1.5.1
✓ ggplot2 3.4.4 ✓ tibble 3.2.1
✓ lubridate 1.9.3 ✓ tidyr 1.3.0
✓ purrr 1.0.2
---- Conflicts
tidyverse_conflicts( ) ----
x dplyr::arrange( ) masks plyr::arrange( )
x purrr::compact( ) masks plyr::compact( )
x dplyr::count( ) masks plyr::count( )
x dplyr::desc( ) masks plyr::desc( )
x dplyr::failwith( ) masks plyr::failwith( )
x dplyr::filter() masks stats::filter( )
x dplyr::id( ) masks plyr::id( )
x dplyr::lag( ) masks stats::lag( )
x dplyr::mutate( ) masks plyr::mutate( )
x dplyr::rename( ) masks plyr::rename( )
x dplyr::summarise( ) masks plyr::summarise( )
x dplyr::summarize( ) masks plyr::summarize( )
i Use the conflicted package (<http://conflicted.r-lib.org/>) to force all conflicts to
become errors
> library(readxl)
> library(edgeR)
Loading required package: limma
> library(tidyverse)
>
>
> library(ggsignif)
> library(stringr)
> library(reshape2)
> library(gtools)
> library(tidyr)
> library(ggbeeswarm) #https://github.com/eclarke/ggbeeswarm
> library(ggrepel)
Attaching package: ‘reshape2’
The following object is masked from ‘package:tidyr’:
    smiths
Attaching package: ‘scales’
The following object is masked from ‘package:purrr’:
    discard
The following object is masked from ‘package:readr’:
    col_factor
Attaching package: ‘cowplot’
The following object is masked from ‘package:lubridate’:
    stamp
> library(scales)
>
> library(ggplot2)
> #library(ggExtra)
#https://cran.r-project.org/web/packages/ggExtra/vignettes/ggExtra.html
>
> library(cowplot)
> library(ggridges)
>
> library(limma)
> library(writexl)
>
>
>
> getwd( )
[1] ″/scratch/gilbreth/cbeveri/Scholar_HOME/Scholar_HOME_orig/Scholar_HOME_1/
Agilent_6495_QQQ_LLM/DEMO″
> current_directory <− getwd( )
>
> # Append ′/demo_data/′ to the current directory
> # Using file.path( ) is more robust across different operating systems
> new_directory <− file.path(current_directory, ″demo_data″)
>
> # Set the working directory to the new path
> setwd(new_directory)
>
> # Verify the change
...
+ # cells_lipid_expr %>%
+ # make_heatmap(design_expr, gr_expr, contrasts_expr, title_for_plot,
+ # file = paste(″plots/Heatmap_″,title_for_plot,″.svg″,sep=″))
+ }
Output is truncated. View as a scrollable element or open in a text editor. Adjust cell
output settings...
Rows: 3227 Columns: 31
---- Column specification
Delimiter: ″,″
chr (6): Lipid, Class, Title1, Title2, Title, Blank_name
dbl (25): DOD93_F4_Female_5xFAD_cerebellum,
DOD94_F3_Female_WT_cerebellum, D...
i Use ‘spec( )‘ to retrieve the full column specification for this data.
i Specify the column types or set ‘show_col_types = FALSE‘ to quiet this message.
Scale for fill is already present.
Adding another scale for fill, which will replace the existing scale.
Saving 7 x 7 in image
Picking joint bandwidth of 0.0456
Rows: 3227 Columns: 31
---- Column specification
Delimiter: ″,″
chr (6): Lipid, Class, Title1, Title2, Title, Blank_name
dbl (25): DOD93_F4_Female_5xFAD_cortex, DOD94_F3_Female_WT_cortex,
DOD94_F4_...
i Use ‘spec( )‘ to retrieve the full column specification for this data.
i Specify the column types or set ‘show_col_types = FALSE‘ to quiet this message.
Scale for fill is already present.
Adding another scale for fill, which will replace the existing scale.
Saving 7 x 7 in image
Picking joint bandwidth of 0.0456
Rows: 3227 Columns: 31
...
Adding another scale for fill, which will replace the existing scale.
Saving 7 x 7 in image
Picking joint bandwidth of 0.051
There were 13 warnings (use warnings( ) to see them)
Output is truncated. View as a scrollable element or open in a text editor. Adjust cell
output settings...
>
>
>
>
>
Meow! I've filtered the data and written two JSONs. The first JSON has data for ′5xFAD′
genotype and ′hippocampus′ brain region. The second JSON has data for ′WT′ genotype
and ′hippocampus′ brain region. The files are located at
/scratch/gilbreth/cbeveri/Scholar_HOME/Scholar_HOME_orig/Scholar_HOME_1/
Agilent_6495_QQQ_LLM/DEMO/demo_data/JSON/filter_keys_1.json and
/scratch/gilbreth/cbeveri/Scholar_HOME/Scholar_HOME_orig/Scholar_HOME_1/
Agilent_6495_QQQ_LLM/DEMO/demo_data/JSON/filter_keys_2.json.
  ok thanks
Your welcome!
```

The user can then ask to perform comparative analysis for the selection of groups for statistical analysis. The AI agent for comparative analysis starts by asking the user which groups it would like to compare. The user can explore the meaning of each group, receive recommendations for comparisons, and request the AI to relate this information to scientifically relevant topics. In the provided example, the user asks the AI agent what genotype and brain region options are available for comparative analysis and how they relate to Alzheimer's disease. The agent iterative uses the tool for explorative JSON analysis to access information on what genotypes and brain regions are presented. The agent then elaborates on the meanings of 5×FAD and WT, alongside descriptions of the roles of each brain regions in the dataset. The AI agent also states that the cortex and hippocampus are the most affected in Alzheimer's disease. The interaction is shown in Table 1. Background information on specific genotypes, brain regions, and Alzheimer's disease was not provided to the agent in either the base prompt or CSV input (processed results from CLAW), and the resulting output was generated based on the LLM's domain of knowledge. The user follows up by saying “ok lets do 5×FAD hippo vs WT hippo.” The AI-model correctly interprets “hippo” as meaning the hippocampus and performs comparative analysis after confirmation with the user. CLAW's statistical analysis is automatically executed based on the groups selected by the user, ensuring that the analysis is tailored to the user request. All results, including custom plots, are saved automatically. The full interaction is shown in Table 1.

After running CLAW's integrated AI agent and suite of statistical software to perform comparative lipidomic analysis the user may want additional information about the generated data including the creation of specific plots derived from the results. This can be accomplished by using the E2B data analysis agent which is designed to execute LLM generated Python code for targeted data analysis and plotting in a sandboxed cloud environment. In one example, results on 5×FAD hippocampus vs WT hippocampus are uploaded to a cloud environment and the agent is provided with a short description of how the results are formatted. The human asks the agent to calculate the number of upregulated and downregulated lipids in each class with an FDR value of less than 0.1 (see Table 6, provided below). The agent recognizes that logFC indicates lipid regulation and uses the LLM to generate custom Python code to filter and calculate the upregulation and downregulation numbers from the result CSV file. The agent executes the custom code in a controlled environment to perform the analysis. During the generation of the plots, the AI mistakenly inputs ‘LogFC’ instead of ‘logFC’, resulting in an error. To resolve this, the agent accesses the data file to identify the correct column heading. This incident highlights the capabilities of AI agents, demonstrating that they can manage inexact inputs and autonomously debug issues. This is shown in Table 2 and FIG. 3e, discussed below.

Reference is made to Table 2 which provides an example of an agentic trace of user-define statistical analysis and plotting on comparative lipidomic data. The user asks the AI agent to generate a LogFC distribution of differentially expressed lipids in each lipid class. The users request includes the wording ‘LogFC’ while the actual column title its ‘logFC.’ The AI agent uses the LLM to generate code to create this plot, but the column name is incorrect on the first attempt. The agent corrects itself by generating code to inspect the data file and finding the correct format for the column name. The code is then modified to reflect this change and re executed in the cloud environment to generate the LogFC distribution plot shown in FIG. 3e.

TABLE 2
Agentic trace of user-define statistical analysis
and plotting on comparative lipidomic data

```
Input:
Make me distribution plot of LogFC for each lipid type only considering lipids with
FDR < 0.1″
Agent Trace:
> Entering new AgentExecutor chain...
Could not parse tool input: {′arguments′: ′{\n ″python_code″: ″\nimport pandas as
pd\nimport matplotlib.pyplot as plt\nimport seaborn as sns\n\n# Load the data\ndata
= pd.read_csv(\′/home/user/Genotype_ 5xFAD_{——}Brain Region_ hippocampus vs
Genotype_ WT_{——}Brain Region_ hippocampus_{——}full.csv\′)\n\n# Filter the
data\nfiltered_data = data[data[\′FDR\′] < 0.1]\n\n# Create a distribution plot for each
lipid type\nlipid_types = filtered_data[\′type\′].unique( )\nfor lipid_type in
lipid_types:\n lipid_data = filtered_data[filtered_data[\′type\′] == lipid_type]\n
sns.distplot(lipid_data[\′logFC\′], hist = False, kde = True, \n kde_kws =
{\′linewidth\′: 3},\n label = lipid_type)\n \n# Plot
formatting\nplt.legend(prop={\′size\′: 16}, title = \′Lipid Types\′)\nplt.title(\′Density
Plot with Multiple Lipid Types\′)\nplt.xlabel(\′LogFC\′)\nplt.ylabel(\′Density\′)
\n\nplt.show( )\n ″\n}′, ′name′: ′e2b_data_analysis′} because the ‘arguments‘ is not
valid JSON.Invalid or incomplete responseCould not parse tool input: {′arguments′:
′{\n ″python_code″: ″\nimport pandas as pd\nimport matplotlib.pyplot as plt\nimport
seaborn as sns\n\n# Load the data\ndata = pd.read_csv(\′/home/user/Genotype_{—}
5xFAD_{——}Brain Region_ hippocampus vs Genotype_ WT_{——}Brain Region_{—}
hippocampus_{——}full.csv\′)\n\n# Filter the data\nfiltered_data = data[data[\′FDR\′] <
0.1]\n\n# Create a distribution plot for each lipid type\nlipid_types =
filtered_data[\′type\′].unique( )\nfor lipid_type in lipid_types:\n lipid_data =
filtered_data[filtered_data[\′type\′] == lipid_type]\n
sns.distplot(lipid_data[\′logFC\′], hist = False, kde = True, \n kde_kws =
{′\linewidth\′: 3},\n label = lipid_type)\n \n# Plot
formatting\nplt.legend(prop={\′size\′: 16}, title = \′Lipid Types\′)\nplt.title(\′Density
Plot with Multiple Lipid Types\′)\nplt.xlabel(\′LogFC\′)\nplt.ylabel(\′Density\′)
\n\nplt.show( )\n ″\n}′, ′name′: ′e2b_data_analysis′} because the ‘arguments‘ is not
valid JSON.Invalid or incomplete response
Invoking: ‘e2b_data_analysis‘ with ‘{′python_code′: ″\nimport pandas as pd\nimport
matplotlib.pyplot as plt\nimport seaborn as sns\n\n# Load the data\ndata =
pd.read_csv(′/home/user/Genotype_ 5xFAD_{——}Brain Region_ hippocampus vs
Genotype_ WT_{——}Brain Region_ hippocampus_{——}full.csv′)\n\n# Filter the
data\nfiltered_data = data[data[′FDR′] < 0.1]\n\n# Create a distribution plot for each
lipid type\nlipid_types = filtered_data[′type′].unique( )\nfor lipid_type in lipid_types:
\n lipid_data = filtered_data[filtered_data[′type′] == lipid_type]\n
sns.distplot(lipid_data[′logFC′], hist = False, kde = True, \n kde_kws =
{′linewidth′: 3},\n label = lipid_type)\n \n# Plot
formatting\nplt.legend(prop={′size′: 16}, title = ′Lipid Types′)\nplt.title(′Density Plot
with Multiple Lipid Types′)\nplt.xlabel(′LogFC′)\nplt.ylabel(′Density′)\n\nplt.show( )
\n″}‘
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
stderr: /tmp/main-1709248116.9551497.py:9: UserWarning:
stderr:
stderr: ‘distplot‘ is a deprecated function and will be removed in seaborn v0.14.0.
stderr:
stderr: Please adapt your code to use either ‘displot‘ (a figure-level function with
stderr: similar flexibility) or ‘kdeplot‘ (an axes-level function for kernel density
plots).
stderr:
stderr: For a guide to updating your code to use the new functions, please see
stderr: https://gist.github.com/mwaskom/de44147ed2974457ad6372750bbe5751
stderr:
stderr: sns.distplot(lipid_data[′logFC′], hist=False, kde=True, kde_kws={′linewidth′:
3}, label=lipid_type)
New matplotlib chart generated: /home/user/artifacts/figure_20240229-230839.png
Failed to process artifact
Traceback (most recent call last):
  File ″/home/cbeveri/.conda/envs/cent7/2020.11-py38/CLAW/lib/python3.9/site-
packages/e2b/templates/data_analysis.py″, line 78, in register_artifacts
    on_artifact_func(artifact)
  File ″/tmp/ipykernel_75208/2889516165.py″, line 19, in save_artifact
    with open(f″./charts/{basename}″, ″wb″) as f:
  File ″/home/cbeveri/.conda/envs/cent7/2020.11-py38/CLAW/lib/python3.9/site-
packages/IPython/core/interactiveshell.py″, line 282, in _modified_open
    return io_open(file, *args, **kwargs)
FileNotFoundError: [Errno 2] No such file or directory: ′./charts/figure_20240229-
230839.png′
stdout: None
{″stdout″: ″None″, ″stderr″: ″/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n ‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)\n/tmp/main-1709248116.9551497.py:9: UserWarning:
\n\n‘distplot‘ is a deprecated function and will be removed in seaborn
v0.14.0.\n\nPlease adapt your code to use either ‘displot‘ (a figure-level function
with\nsimilar flexibility) or ‘kdeplot‘ (an axes-level function for kernel density
plots).\n\nFor a guide to updating your code to use the new functions, please
see\nhttps://gist.github.com/mwaskom/de44147ed2974457ad6372750bbe5751\n\n
sns.distplot(lipid_data[′logFC′], hist=False, kde=True, kde_kws={′linewidth′: 3},
label=lipid_type)″, ″artifacts″: [″/home/user/artifacts/figure_20240229-
230839.png″]}Here is the distribution plot of LogFC for each lipid type, considering
only lipids with FDR < 0.1:
![Distribution Plot](sandbox:/home/user/artifacts/figure_20240229-230839.png)
Please note that the ‘distplot‘ function used to generate this plot is deprecated in the
latest version of seaborn and will be removed in seaborn v0.14.0. It is recommended
to use either ‘displot‘ (a figure-level function with similar flexibility) or ‘kdeplot‘ (an
axes-level function for kernel density plots) in the future.
> Finished chain.
```

Reference is also made to FIG. 3e which provides a plot of density vs. LogFC for different types of lipid types.

Next, the user asks about the top 5 most upregulated and downregulated lipids, a question the AI agent addresses accurately (see FIG. 3f). Finally, the user requests the agent to create a bar plot showcasing the differentially expressed lipids, both upregulated and downregulated, with up and down regulated bars facing opposite directions (see Figure S6, discussed below). This request demonstrates the agent's capability to create plots according to user specifications. These interactions are documented in full in Table 2, Table 3, Table 4, and Table 6 as well as FIG. 3e, FIG. 3h, FIG. 3i, and 3g, discussed below. Other examples of custom plots generated by the AI agent include LogFC distribution plots of significant lipids (see Table 2 and FIG. 3e, discussed below), pie charts showing how the numbers differentially expressed lipids are distributed among classes (see Table 3 and FIG. 3h, discussed below), and ridge plots of LogFC distribution by lipid class (Table 4 and FIG. 3i, discussed below). During the process of generating code for plots or data analysis, the LLM occasionally generates code which results in errors when executed. Instead of immediately ending the code generation process, the agent possesses the capability to debug its own code. The error message is provided back to the agent and the agent automatically attempts to rewrite the code to resolve the issue. This shows the AI agent effectively generates code and presents visualizations of data. Tables 2, 3, 4, 5, 6, FIGS. 3e, 3h, 3i, 3g, 3f, and 3j show the full results from the data analysis AI agent.

Reference is made to FIG. 3f which provides an example of how a user asks CLAW AI agent for top 5 differentially regulated lipids in each direction. The user requests the top five upregulated and downregulated lipids. This refers to the lipids with the five highest and lowest LogFC values respectively. The AI agent understands this request and uses the LLM to generate code which sorts the comparative analysis datafile by LogFC and then access the 5 highest and 5 lowest lipids. The agent summarizes the information it has learned to the user in a clear and concise manner.

Reference is also made to FIG. 3j which provides an example of an agentic trace of user-defined statistical analysis on comparative lipidomic data. The user asks how many lipids have a LogFC value greater than 2 or less than −2. The AI agent uses the LLM to generate python code which filters the comparative analysis data frame to only include lipids which have a LogFC value of greater than 2 or less than −2. The agent then counts the number of lipids in the filtered data frame accounting for uniqueness and returns this number to the user in a conversational manner.

Reference is made to Table 3 which provides an example of an agentic trace of user-define statistical plotting on comparative lipidomic data. The user asks the agent to create a pie chart which shows the distribution of differentially expressed by lipid class. The agent uses the LLM to generate python code to accomplish this task and then executes the code in the cloud environment to generate the plot shown in FIG. 3h.

TABLE 3
Agentic trace of user-define statistical plotting on comparative lipidomic data

```
Input:
Make a Pie chart of number of lipids of each class with less than 0.1 FDR
Agent Trace:
> Entering new AgentExecutor chain...
Could not parse tool input: {′arguments′: ′{\n ″python_code″: ″\nimport pandas as
pd\nimport matplotlib.pyplot as plt\n\n# Load the data\ndata =
pd.read_csv(\′/home/user/Genotype_ 5xFAD_{——}Brain Region_ hippocampus vs
Genotype_ WT_{——}Brain Region_ hippocampus_{——}full.csv\′)\n\n# Filter the
data\nfiltered_data = data[data[\′FDR\′] < 0.1]\n\n# Count the number of lipids in
each class\nlipid_counts = filtered_data[\′Type\′].value_counts( )\n\n# Create a pie
chart\nplt.figure(figsize=(10, 8))\nplt.pie(lipid_counts, labels=lipid_counts.index,
autopct=\′%1.1f%%\′)\nplt.title(\′Number of Lipids of Each Class with FDR < 0.1\′)
\nplt.show( )\n ″\n}′, ′name′: ′e2b_data_analysis′} because the ‘arguments‘ is not
valid JSON.Invalid or incomplete response
Invoking: ‘e2b_data_analysis‘ with ‘{′python_code′: ″\nimport pandas as pd\nimport
matplotlib.pyplot as plt\n\n# Load the data\ndata =
pd.read_csv(′/home/user/Genotype_ 5xFAD_{——}Brain Region_ hippocampus vs
Genotype_ WT_{——}Brain Region_ hippocampus_{——}full.csv′)\n\n# Filter the
data\nfiltered_data = data[data[′FDR′] < 0.1]\n\n# Count the number of lipids in each
class\nlipid_counts = filtered_data[′Type′].value_counts( )\n\n# Create a pie
chart\nplt.figure(figsize=(10, 8))\nplt.pie(lipid_counts, labels=lipid_counts.index,
autopct=′%1.1f%%′)\nplt.title(′Number of Lipids of Each Class with FDR < 0.1′)
\nplt.show( )\n″}‘
stderr: Traceback (most recent call last):
stderr: File ″/usr/local/lib/python3.11/site-packages/pandas/core/indexes/base.py″,
line 3805, in get_loc
stderr: return self._engine.get_loc(casted_key)
stderr: \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }
stderr: File ″index.pyx″, line 167, in pandas._libs.index.IndexEngine.get_loc
stderr: File ″index.pyx″, line 196, in pandas._libs.index.IndexEngine.get_loc
stderr: File ″pandas/_libs/hashtable_class_helper.pxi″, line 7081, in
pandas._libs.hashtable.PyObjectHashTable.get_item
stderr: File ″pandas/_libs/hashtable_class_helper.pxi″, line 7089, in
pandas._libs.hashtable.PyObjectHashTable.get_item
stderr: KeyError: ′Type′
stderr:
stderr: The above exception was the direct cause of the following exception:
stderr:
stderr: Traceback (most recent call last):
stderr: File ″/tmp/main-1709248739.7624724.py″, line 5, in <module>
stderr: lipid_counts = filtered_data[′Type′].value_counts( )
stderr: ~~~~~~~~~~~~~\hat{ }\hat{ }\hat{ }\hat{ }\hat{ }\hat{ }\hat{ }\hat{ }
stderr: File ″/usr/local/lib/python3.11/site-packages/pandas/core/frame.py″, line
4090, in _{——}getitem_{——}
stderr: indexer = self.columns.get_loc(key)
stderr: \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }
stderr: File ″/usr/local/lib/python3.11/site-packages/pandas/core/indexes/base.py″,
line 3812, in get_loc
stderr: raise KeyError(key) from err
stderr: KeyError: ′Type′
{″stdout″: ″″, ″stderr″: ″Traceback (most recent call last):\n File
\″/usr/local/lib/python3.11/site-packages/pandas/core/indexes/base.py\″, line 3805, in
get_loc\n return self._engine.get_loc(casted_key)\n
\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\n File
\″index.pyx\″, line 167, in
pandas._libs.index.IndexEngine.get_loc\n File \″index.pyx\″, line 196, in
pandas._libs.index.IndexEngine.get_loc\n File
\″pandas/_libs/hashtable_class_helper.pxi\″, line 7081, in
pandas._libs.hashtable.PyObjectHashTable.get_item\n File
\″pandas/_libs/hashtable_class_helper.pxi\″, line 7089, in
pandas._libs.hashtable.PyObjectHashTable.get_item\nKeyError: ′Type′\n\nThe
above exception was the direct cause of the following exception:\n\nTraceback (most
recent call last):\n File \″/tmp/main-1709248739.7624724.py\″, line 5, in
<module>\n lipid_counts = filtered_data[′Type′].value_counts( )\n
~~~~~~~~~~~~~\hat{ }\hat{ }\hat{ }\hat{ }\hat{ }\hat{ }\hat{ }\hat{ }\n File
\″/usr/local/lib/python3.11/site-packages/pandas/core/frame.py\″, line 4090, in
_{——}getitem_{——}\n indexer = self.columns.get_loc(key)\n
\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\n File
\″/usr/local/lib/python3.11/site-packages/pandas/core/indexes/base.py\″, line 3812, in
get_loc\n raise KeyError(key) from err\nKeyError: ′Type′″, ″artifacts″: [ ]}
Invoking: ‘e2b_data_analysis‘ with ‘{′python_code′: ″\nimport pandas as pd\n\n#
Load the data\ndata = pd.read_csv(′/home/user/Genotype_ 5xFAD_{——}Brain Region_{—}
hippocampus vs Genotype_ WT_{——}Brain Region_ hippocampus_{——}full.csv′)\n\n# Print
the column names \ndata.columns\n″}‘
responded: I apologize for the error. It seems like there is no column named ′Type′ in
the dataset. Let me first check the columns available in the dataset.
stdout: Index([′lipid′, ′logFC′, ′logCPM′, ′LR′, ′PValue′, ′FDR′, ′type′,
stdout: ′DOD93_F4_Female_5xFAD_hippocampus′,
stdout: ′DOD94_F4_Female_5xFAD_hippocampus′,
′FAD185_M1_Male_5xFAD_hippocampus′,
stdout: ′FAD185_M3_Male_5xFAD_hippocampus′,
′FAD189_M1_Male_5xFAD_hippocampus′,
stdout: ′FAD189_M2_Male_5xFAD_hippocampus′,
′DOD94_F3_Female_WT_hippocampus′,
stdout: ′FAD184_F3_Female_WT_hippocampus′,
′FAD184_F4_Female_WT_hippocampus′,
stdout: ′FAD185_M4_Male_WT_hippocampus′,
′FAD189_M3_Male_WT_hippocampus′,
stdout: ′Blank_Blank_Blank_Blank_Blank′],
stdout: dtype=′object′)
{″stdout″: ″Index([′lipid′, ′logFC′, ′logCPM′, ′LR′, ′PValue′, ′FDR′, ′type′,\n
′DOD93_F4_Female_5xFAD_hippocampus′,\n
′DOD94_F4_Female_5xFAD_hippocampus′,
′FAD185_M1_Male_5xFAD_hippocampus′,\n
′FAD185_M3_Male_5xFAD_hippocampus′,
′FAD189_M1_Male_5xFAD_hippocampus′,\n
′FAD189_M2_Male_5xFAD_hippocampus′,
′DOD94_F3_Female_WT_hippocampus′,\n
′FAD184_F3_Female_WT_hippocampus′, ′FAD184_F4_Female_WT_hippocampus′,
\n ′FAD185_M4_Male_WT_hippocampus′,
′FAD189_M3_Male_WT_hippocampus′,\n ′Blank_Blank_Blank_Blank_Blank′],
\n dtype=′object′)″, ″stderr″: ″″, ″artifacts″: [ ]}
Invoking: ‘e2b_data_analysis‘ with ‘{′python_code′: ″\nimport pandas as pd\nimport
matplotlib.pyplot as plt\n\n# Load the data\ndata =
pd.read_csv(′/home/user/Genotype_ 5xFAD_{——}Brain Region_ hippocampus vs
Genotype_ WT_{——}Brain Region_ hippocampus_{——}full.csv′)\n\n# Filter the
data\nfiltered_data = data[data[′FDR′] < 0.1]\n\n# Count the number of lipids in each
class\nlipid_counts = filtered_data[′type′].value_counts( )\n\n# Create a pie
chart\nplt.figure(figsize=(10, 8))\nplt.pie(lipid_counts, labels=lipid_counts.index,
autopct=′%1.1f%%′)\nplt.title(′Number of Lipids of Each Class with FDR < 0.1′)
\nplt.show( )\n″}‘
responded: I apologize for the confusion earlier. The column for lipid class is
actually named ′type′ and not ′Type′. Let's correct this and try to create the pie chart
again.
New matplotlib chart generated: /home/user/artifacts/figure_20240229-231925.png
Failed to process artifact
Traceback (most recent call last):
  File ″/home/cbeveri/.conda/envs/cent7/2020.11-py38/CLAW/lib/python3.9/site-
packages/e2b/templates/data_analysis.py″, line 78, in register_artifacts
    on_artifact_func(artifact)
  File ″/tmp/ipykernel_75208/2889516165.py″, line 19, in save_artifact
    with open(f″./charts/{basename}″, ″wb″) as f:
  File ″/home/cbeveri/.conda/envs/cent7/2020.11-py38/CLAW/lib/python3.9/site-
packages/IPython/core/interactiveshell.py″, line 282, in _modified_open
    return io_open(file, *args, **kwargs)
FileNotFoundError: [Errno 2] No such file or directory: ′./charts/figure_20240229-
231925.png′
stdout: None
{″stdout″: ″None″, ″stderr″: ″″, ″artifacts″: [″/home/user/artifacts/figure_20240229-
231925.png″]} Here is the pie chart showing the number of lipids of each class with
an FDR less than 0.1.
![Pie Chart](sandbox:/home/user/artifacts/figure_20240229-231925.png)
> Finished chain.
```

Reference is also made to FIG. 3h which provides a pie-chart showing number of lipids of each class with FDR<1.

Reference is further made to Table 4 which provides an example of an agentic trace of user-define statistical plotting on comparative lipidomic data. The user asks the AI agent to generate a ridge plot of the logFC distribution of differentially expressed lipids by lipid class, as shown in FIG. 3i. The agent uses the LLM to write python code which can accomplish this task and then executes this code in a remote sandboxed environment.

TABLE 4
Agentic trace of user-define statistical plotting on comparative lipidomic data

```
Input:
Make me ridge plot of LogFC for each lipid type only considering lipids with FDR <
0.1
Agent Trace:
> Entering new AgentExecutor chain...
Invoking: ‘e2b_data_analysis‘ with ‘{′python_code′: ′import pandas as pd\nimport
seaborn as sns\nimport matplotlib.pyplot as plt\n\n# Load the data\npath =
\′/home/user/Genotype_ 5xFAD_{——}Brain Region_ hippocampus vs Genotype_{—}
WT_{——}Brain Region_ hippocampus_{——}full.csv\′\ndata = pd.read_csv(path)\n\n# Filter
the data\nfiltered_data = data[data[\′FDR\′] < 0.1]\n\n# Create a ridge
plot\nsns.set(style=″white″, rc={″axes.facecolor″: (0, 0, 0, 0)})\n\n# Initialize the
FacetGrid object\npal = sns.cubehelix_palette(10, rot=−.25, light=.7)\ng =
sns.FacetGrid(filtered_data, row=″type″, hue=″type″, aspect=15, height=.5,
palette=pal)\n\n# Draw the densities in a few steps\ng.map(sns.kdeplot, ″logFC″,
clip_on=False, shade=True, alpha=1, lw=1.5, bw=.2)\ng.map(sns.kdeplot, ″logFC″,
clip_on=False, color=″w″, lw=2, bw=.2)\ng.map(plt.axhline, y=0, lw=2,
clip_on=False)\n\n# Define and use a simple function to label the plot in axes
coordinates\ndef label(x, color, label):\n ax = plt.gca( )\n ax.text(0, .2, label,
fontweight=″bold″, color=color,\n ha=″left″, va=″center″,
transform=ax.transAxes)\n\ng.map(label, ″logFC″)\n\n# Set the subplots to
overlap\ng.fig.subplots_adjust(hspace=−.25)\n\n# Remove axes details that don\'t
play well with overlap\ng.set_titles(″″)\ng.set(yticks=[ ])\ng.despine(bottom=True,
left=True)\n\nplt.show( )′}‘
stderr: /usr/local/lib/python3.11/site-packages/seaborn/axisgrid.py:123:
UserWarning: Tight layout not applied. tight_layout cannot make axes height small
enough to accommodate all axes decorations.
stderr: self._figure.tight_layout(*args, **kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
FutureWarning:
stderr:
stderr: ‘shade‘ is now deprecated in favor of ‘fill‘; setting ‘fill=True‘.
stderr: This will become an error in seaborn v0.14.0; please update your code.
stderr:
stderr: func(*plot_args, **plot_kwargs)
stderr: /usr/local/lib/python3.11/site-packages/seaborn/axisgrid.py:123:
UserWarning: Tight layout not applied. tight_layout cannot make axes height small
enough to accommodate all axes decorations.
stderr: self._figure.tight_layout(*args, **kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:854:
UserWarning:
stderr:
stderr: The ‘bw‘ parameter is deprecated in favor of ‘bw_method‘ and ‘bw_adjust‘.
stderr: Setting ‘bw_method=0.2‘, but please see the docs for the new parameters
stderr: and update your code. This will become an error in seaborn v0.14.0.
stderr:
stderr: func(*plot_args, **plot_kwargs)
stderr: /usr/local/lib/python3.11/site-packages/seaborn/axisgrid.py:123:
UserWarning: Tight layout not applied. tight_layout cannot make axes height small
enough to accommodate all axes decorations.
stderr: self._figure.tight_layout(*args, **kwargs)
stderr: /usr/local/lib/python3.11/site-packages/seaborn/axisgrid.py:123:
UserWarning: Tight layout not applied. tight_layout cannot make axes height small
enough to accommodate all axes decorations.
stderr: self._figure.tight_layout(*args, **kwargs)
stderr: /usr/local/lib/python3.11/site-packages/seaborn/axisgrid.py:123:
UserWarning: Tight layout not applied. tight_layout cannot make axes height small
enough to accommodate all axes decorations.
stderr: self._figure.tight_layout(*args, **kwargs)
New matplotlib chart generated: /home/user/artifacts/figure_20240229-232435.png
Failed to process artifact
Traceback (most recent call last):
  File ″/home/cbeveri/.conda/envs/cent7/2020.11-py38/CLAW/lib/python3.9/site-
packages/e2b/templates/data_analysis.py″, line 78, in register_artifacts
    on_artifact_func(artifact)
  File ″/tmp/ipykernel_75208/2889516165.py″, line 19, in save_artifact
    with open(f″./charts/{basename}″, ″wb″) as f:
  File ″/home/cbeveri/.conda/envs/cent7/2020.11-py38/CLAW/lib/python3.9/site-
packages/IPython/core/interactiveshell.py″, line 282, in _modified_open
    return io_open(file, *args, **kwargs)
FileNotFoundError: [Errno 2] No such file or directory: ′./charts/figure_20240229-
232435.png′
stdout: None
{″stdout″: ″None″, ″stderr″:
″/usr/local/lib/python3.11/site-packages/seaborn/axisgrid.py:123: UserWarning:
Tight layout not applied. tight_layout cannot make axes height small enough to
accommodate all axes decorations.\n self._figure.tight_layout(*args,
**kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
FutureWarning: \n\n‘shade‘ is now deprecated in favor of ‘fill‘; setting ‘fill=True‘.
\nThis will become an error in seaborn v0.14.0; please update your code.\n\n
func(*plot_args,
**plot_kwargs)\n/usr/local/lib/python3.11/site-packages/seaborn/axisgrid.py:123:
UserWarning: Tight layout not applied. tight_layout cannot make axes height small
enough to accommodate all axes decorations.\n self._figure.tight_layout(*args,
**kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:854:
UserWarning: \n\nThe ‘bw‘ parameter is deprecated in favor of ‘bw_method‘ and
‘bw_adjust‘.\nSetting ‘bw_method=0.2‘, but please see the docs for the new
parameters\nand update your code. This will become an error in seaborn v0.14.0.\n\n
func(*plot_args,
**plot_kwargs)\n/usr/local/lib/python3.11/site-packages/seaborn/axisgrid.py:123:
UserWarning: Tight layout not applied. tight_layout cannot make axes height small
enough to accommodate all axes decorations.\n self._figure.tight_layout(*args,
**kwargs)\n/usr/local/lib/python3.11/site-packages/seaborn/axisgrid.py:123:
UserWarning: Tight layout not applied. tight_layout cannot make axes height small
enough to accommodate all axes decorations.\n self._figure.tight_layout(*args,
**kwargs)\n/usr/local/lib/python3.11/site-packages/seaborn/axisgrid.py:123:
UserWarning: Tight layout not applied. tight_layout cannot make axes height small
enough to accommodate all axes decorations.\n self._figure.tight_layout(*args,
**kwargs)″, ″artifacts″: [″/home/user/artifacts/figure_20240229-232435.png″]}Here
is the ridge plot of LogFC for each lipid type, considering only lipids with FDR <
0.1:
![Ridge Plot](sandbox:/home/user/artifacts/figure_20240229-232435.png)
Please note that the warnings you see are due to some deprecated parameters in the
seaborn library used for plotting. These warnings do not affect the output of the plot.
> Finished chain.
```

Reference is also made to FIG. 3i which provides a graph of density vs. LogFC for different lipid classes.

Reference is further made to Table 5 which provides an example of user requests bar plot of number of significant lipids with custom design features, as shown in FIG. 3g. The user requests a bar plot showing the number of differentially expressed lipids in each class. In this request, the user specifies it would like up and down bars facing opposite directions. The agent uses the LLM to generate python code which creates this plot and executes this code in the cloud environment. This demonstrates the AI agent can take specific requests for visualization of the data.

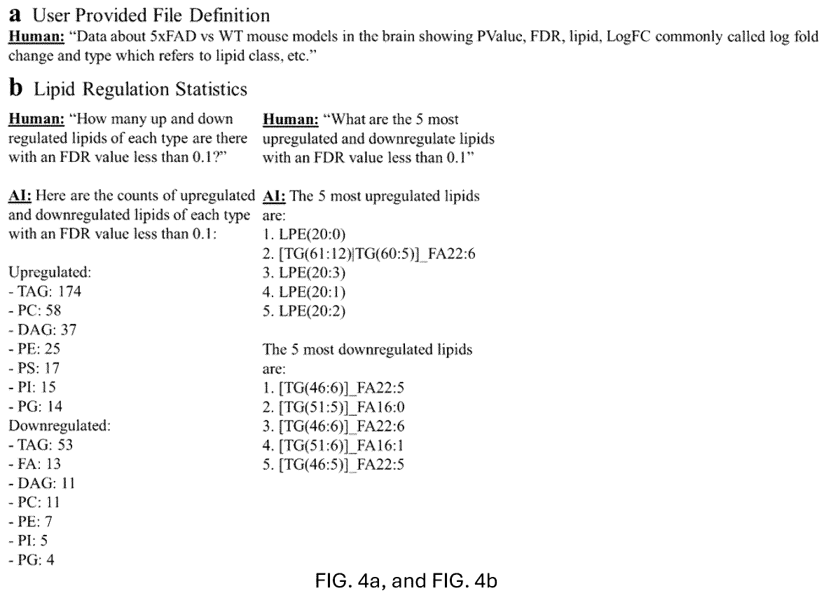

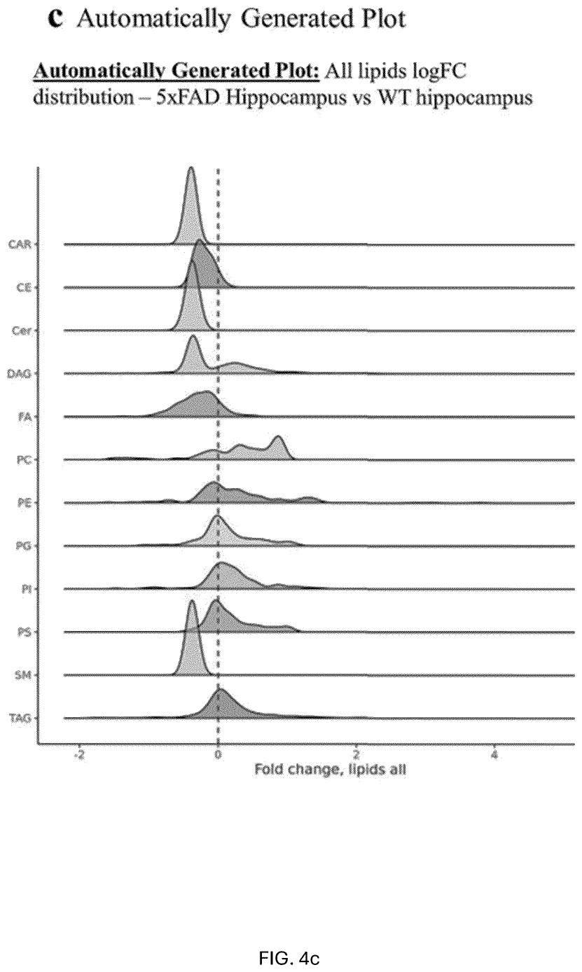

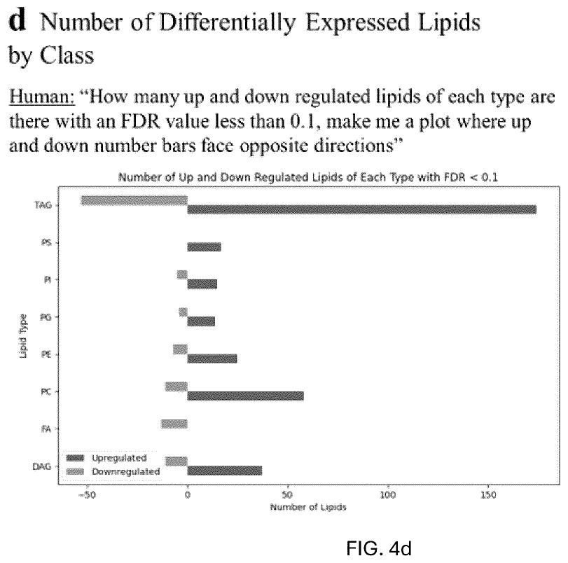

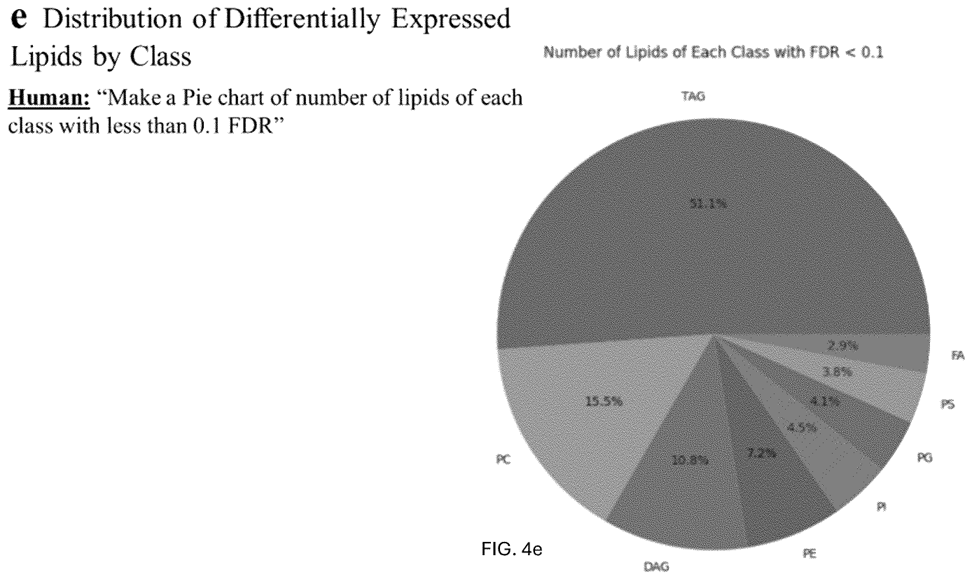

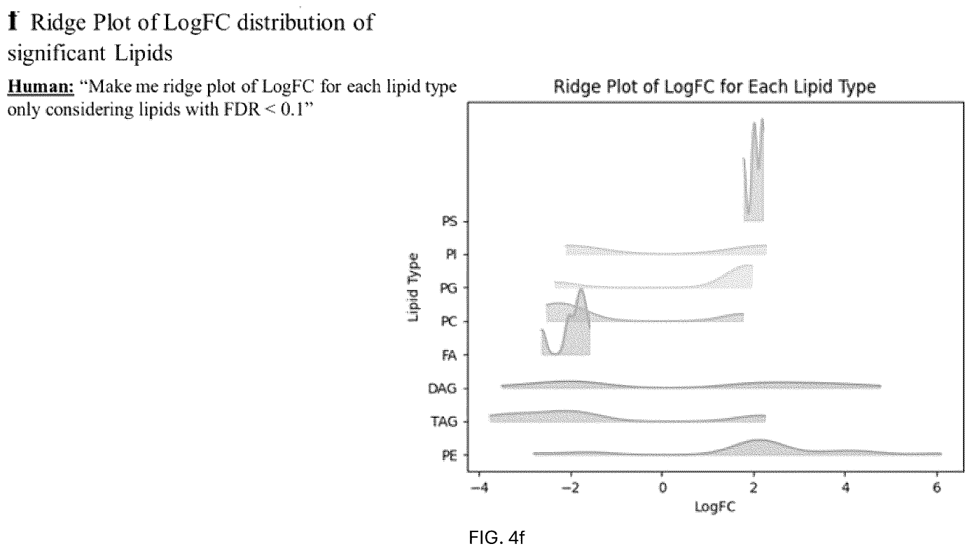

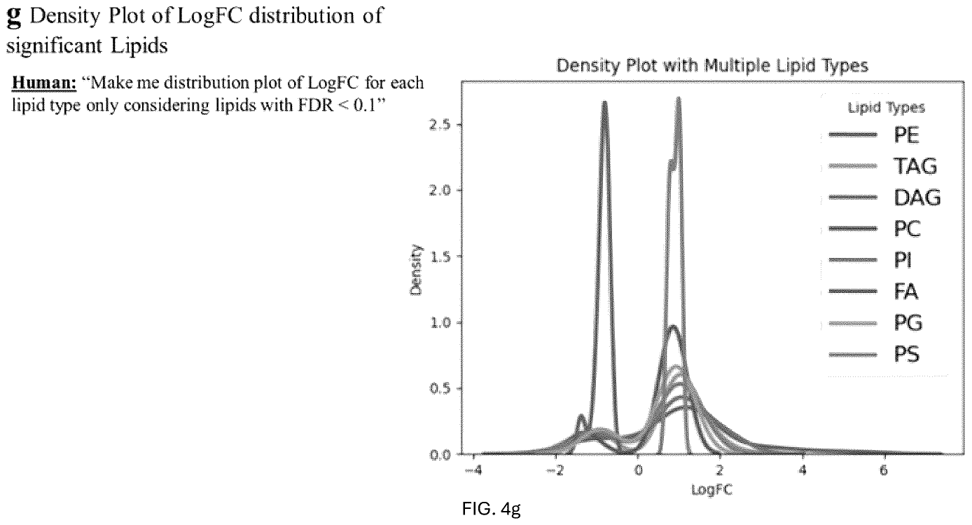

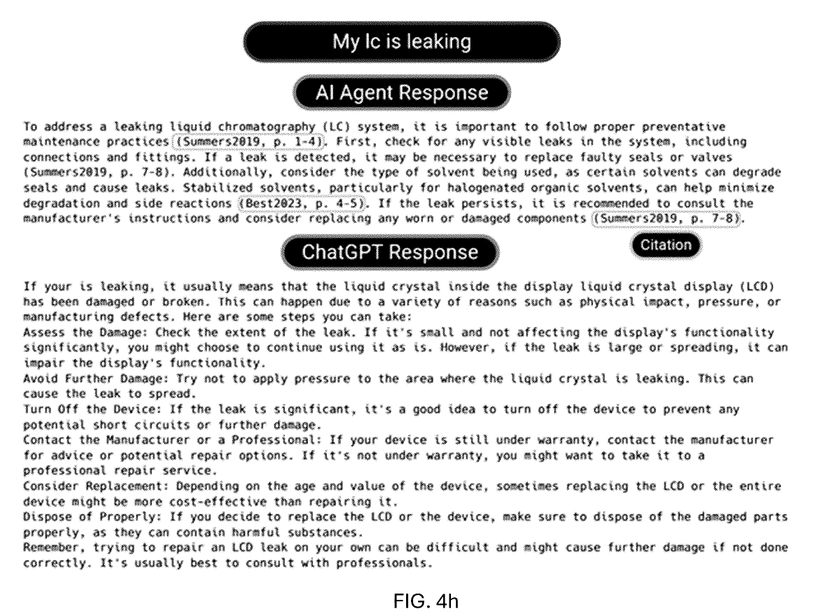

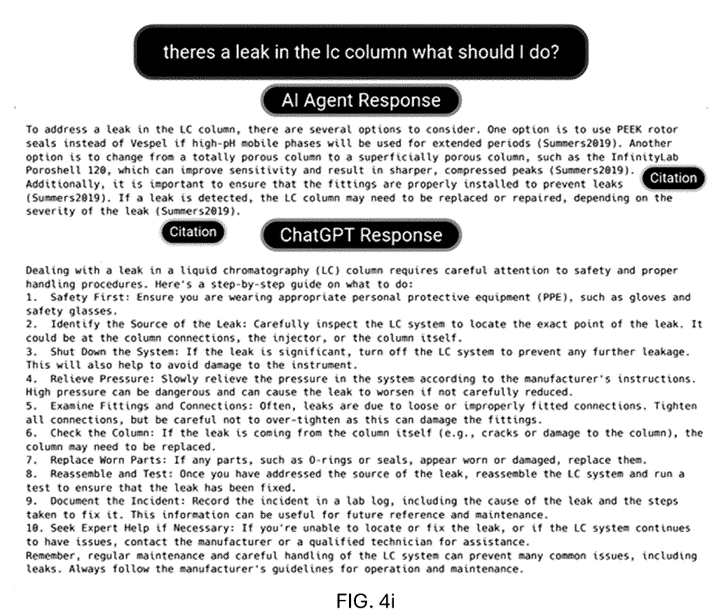

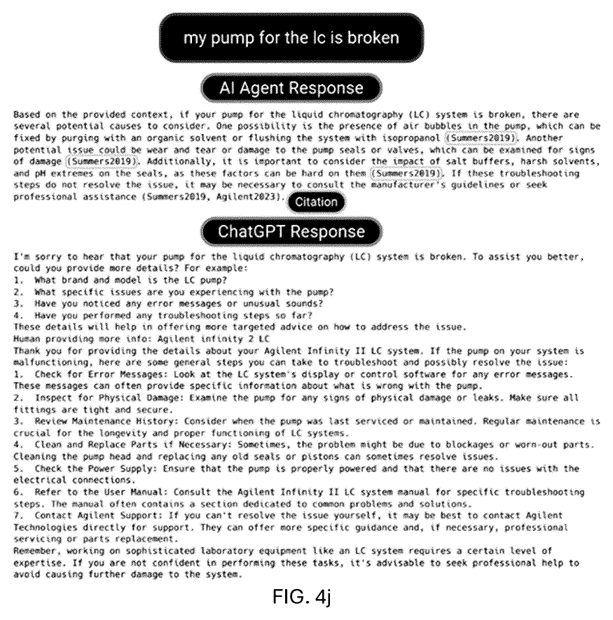

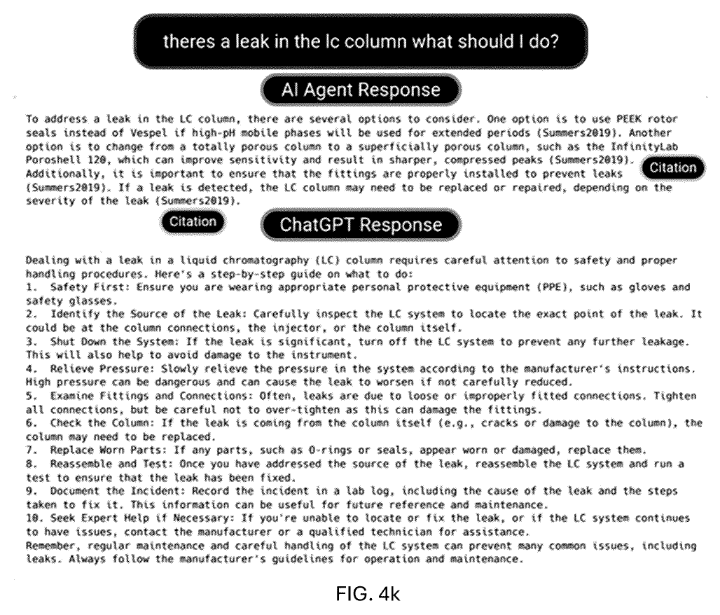

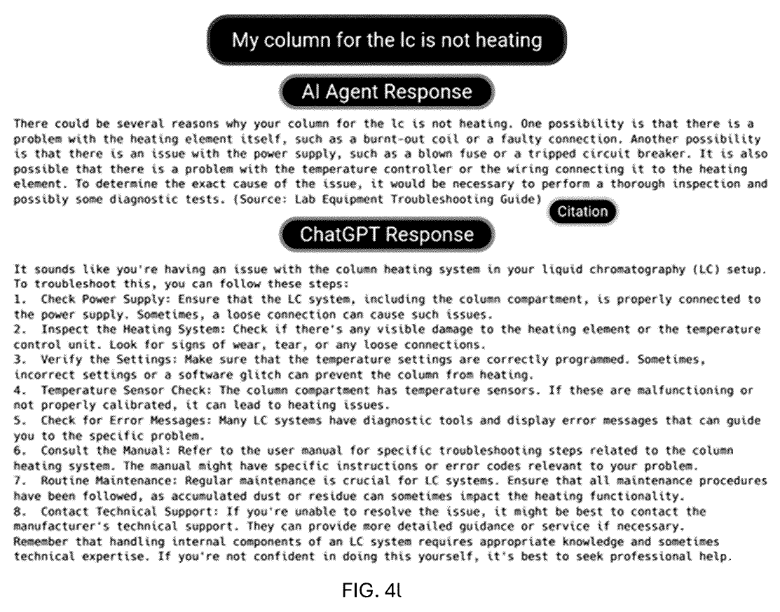

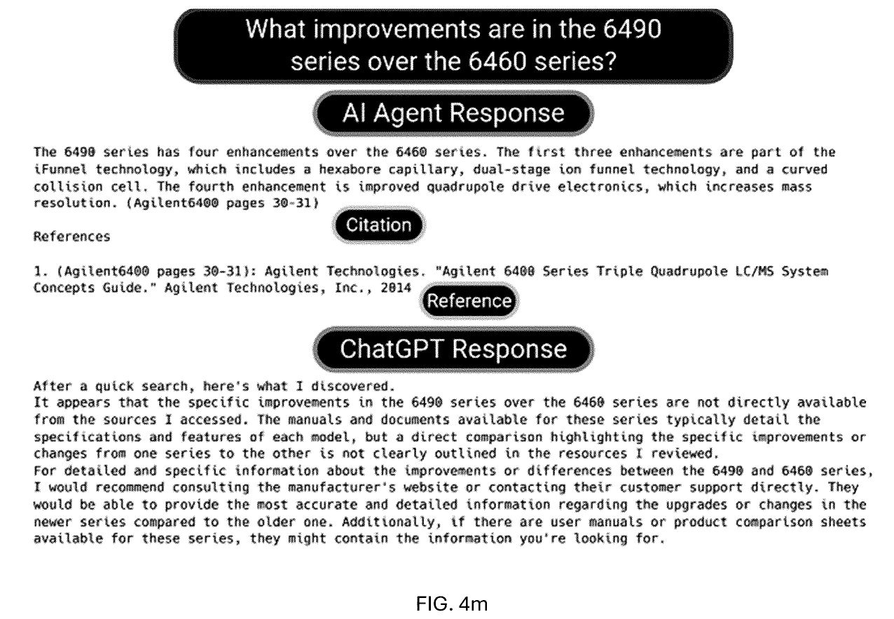

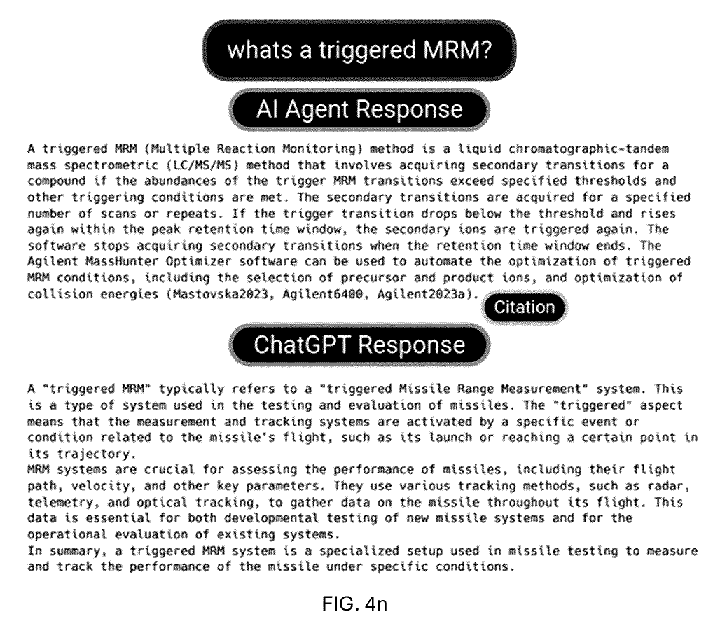

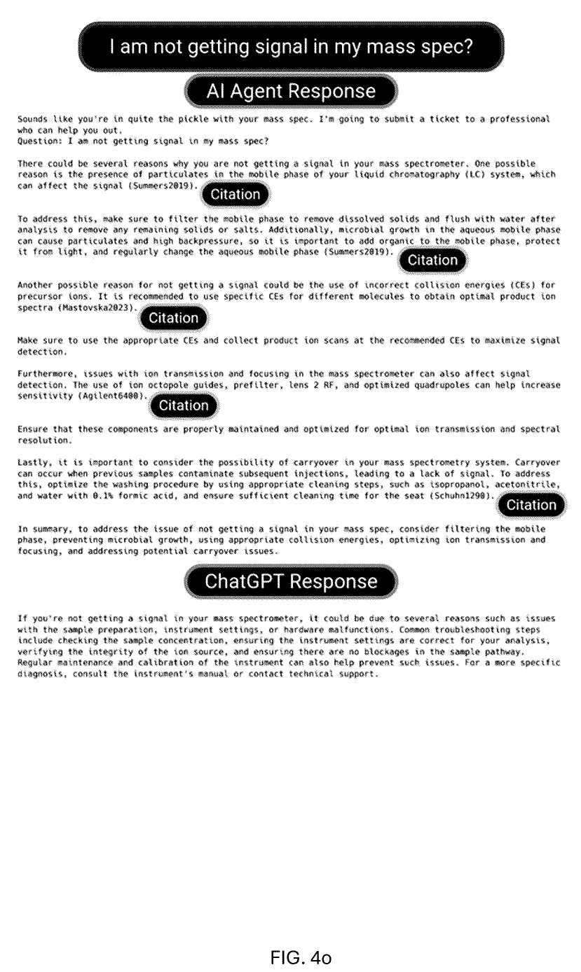

Reference is made to FIGS. 4a-4g which provide an example input to an output from the AI co-pilot for general data analysis. Specifically, FIG. 4a provides a map of how the user provides definition of the lipidomic comparative statistical results file; FIG. 4b provides how a human-agent interaction on general statistical questions on lipid upregulation and downregulation; FIG. 4c provides an interactive plotting of lipid regulation statistics based on specific human request; FIG. 4d provides a graph of lipid type vs. number of lipids; FIG. 4e provides a pie-chart showing the number of lipids of each class; FIG. 4f provides a ridge plot of LogFC for each lipid type; and FIG. 4g provides a density plot with multiple lipid types.

The AI agent manager is equipped with a PaperQA LLM chain as an endpoint, allowing it to redirect technical user requests to an LLM chain with access to instrument manuals, protocols, and other guidelines provided in PDF format. This enables the agent manager to provide precise responses that reference documentation for technical assistance when a user asks questions relating to the Agilent 6495 mass spectrometer, attached LC, or provided protocols. These documents were instrument manuals provided by Agilent related to the maintenance, troubleshooting, and hardware information about the instrument. For instance, when faced with the common issue of a leaking LC, the AI (PaperQA LLM chain) delivers targeted advice, including recommendations to replace defective seals, verify the solvents in use, and underscore the significance of routine preventative maintenance (see FIG. 4h). Furthermore, it points to specific pages within the manual for users seeking more detailed information. We compare this response with the same questions asked to ChatGPT using the GPT 4 model as it is a commonly used generative AI tool by chemists and provides a direct comparison for benchmarking. The response provided by this targeted approach contrasts with ChatGPT 4′ responses, which might mistakenly relate the issue to liquid crystal display screens, illustrating the AI's advantage in offering relevant solutions (see FIG. 4h). Following the previous example, the AI adeptly addresses a question on LC pump breakage, another common issue for LC systems. It identifies air bubbles as a possible cause and recommends system flushing with isopropanol to resolve this. The response further advises inspecting pump seals and valves for wear or damage and cautions against the use of harsh solvents that may deteriorate the seals. For users seeking an in-depth understanding, it directs them to the specific section of the Agilent 1290 Infinity II maintenance manual. In contrast, when presented with the same issue, ChatGPT requests clarification on the LC system model. Upon receiving “Agilent Infinity 2 LC” as a response, ChatGPT provides broad, non-specific advice, including checking for error messages, inspecting for physical damage, reviewing maintenance history, cleaning and replacing parts as necessary, checking the power supply, recommending consultation of the user manual, and suggesting contacting Agilent support. This comparison highlights the AI-copilot's ability to furnish precise solutions by leveraging the manual's content, showcasing its effectiveness over ChatGPT's generalist approach (see FIG. 4i).

Reference is made to FIG. 4h which provides an example of interactions when the user requests advice for a leaking LC. The user asks both sources the question: ‘My lc is leaking.’ The AI agent gives suggestions on how to remedy the leaky LC column with citations from relevant documentation in Agilent's manuals. ChatGPT assumes LC means liquid crystal display. This shows that the AI agent has critical context and information to provide relative answers without additional specification.

Reference is made to FIG. 4i which provides an example of interactions when the user requests advice for a broken LC pump. The user asks the question: ‘my pump for the lc is broken.’ The AI agent gives suggestions on how to fix the LC pump with citations from relevant documentation in Agilent's manuals. ChatGPT asks for more information about the system and then gives general guidance such as checking power supply and contacting Agilent support.

Building on the previous example, another frequent issue encountered by chemists using LC-MS systems is a leaking column. When approached with the concern, “there's a leak in the LC column, what should I do?”, the AI precisely advises on replacing the column and ensuring that all fittings are correctly installed, directly addressing the problem. In contrast, ChatGPT's response, while accurate, encompasses a broader scope, advising to examine fittings and connections, replace worn parts, and check the column, along with extraneous recommendations such as wearing gloves and PPE, as detailed in FIG. 4j, discussed below. Similarly, when confronted with a non-heating LC column, the AI suggests investigating the heating element for issues like a burnt-out coil or a blown fuse and recommends performing diagnostic tests, with specific reference to the Agilent 1290 Infinity II maintenance manual. ChatGPT, on the other hand, provides a more general suggestion to inspect the heating system and check the power supply (see FIG. 4k, discussed below). These instances further underscore the AI's ability to deliver targeted solutions by consulting the manual, contrasting with ChatGPT's broader, less specific guidance, and emphasizing the copilot's superior specificity and relevance in troubleshooting.

Reference is made to FIG. 4j which provides an example interaction of when a user requests advice for a leaking column. The user asks the question: ‘there's a leak in the lc column what should I do?’ The AI agent gives incredibly specific suggestions on situations where different seals or column types would be beneficial with citations from relevant documentation in Agilent's manuals. ChatGPT gives a general answer such replacing the column, inspecting the O-rings or seals, and suggesting seeking expert help if the issue is persistence.

Reference is further made to FIG. 4k which provides an example interaction of when a user requests advice for an LC column not heating. The user asks the question: ‘My column for the lc is not heating’. The AI agent gives suggestions from the equipment troubleshooting guide on inspecting the heating element and power supply with the appropriate citation. ChatGPT gives a similar but slightly more general answer to this question including suggestions to consult the manual or contact technical support.

When asked about mass spectrometer hardware advancements in the Agilent 6490 series compared to the 6460 series, the AI delineates specific enhancements such as the evolution in iFunnel technology, incorporating a hexabore capillary and dual-stage ion funnel technology, alongside a curved collision cell. It also highlights upgrades in electronics facilitating higher mass resolution, directly supplying the information that ChatGPT suggests finding through user manuals, a component that is already integrated into the AI (see FIG. 4l, discussed below). When addressing a question on what a triggered MRM is, the AI precisely explains it as a method that triggers secondary transitions for a compound based on the exceedance of predefined abundance thresholds of the primary MRM transitions and fulfillment of other conditions citing the Agilent 6495c manual. This contrasts with ChatGPT's erroneous interpretation related to missile range measurement, showcasing the AI-copilot's capability to provide accurate and contextually relevant answers (see FIG. 4m, discussed below). In troubleshooting scenarios such as encountering such as the mass spectrometer not having signal, the AI offers a comprehensive approach, recommending flushing the LC solvent to eliminate contamination effects on the signal, adjusting collision energy for optimal fragmentation, inspecting quadrupoles for issues, and addressing sample carry-over through LC system cleaning while citing both the manuals for the Agilent 6495c mass spectrometer and Agilent 1290 Infinity II LC manual. ChatGPT's response pales in specificity, suggesting potential causes like sample preparation, instrument settings, or hardware malfunctions, and further highlighting the AI's proficiency in providing targeted solutions (see FIG. 4n, discussed below). In conclusion, the use of LLM chains to dynamically embed, retrieve, and process relevant documentation excels in providing specific, actionable solutions by consulting and citing various manuals, addressing the unique needs of users with precision, while ChatGPT lacks context making it unable to provide useful answers.

Reference is made to FIG. 4l which provides an example interaction of when the user requests advice for an LC column not heating. The user asks the question: ‘My column for the lc is not heating’. The AI agent gives suggestions from the equipment troubleshooting guide on inspecting the heating element and power supply with the appropriate citation. ChatGPT gives a similar but slightly more general answer to this question including suggestions to consult the manual or contact technical support.

Reference is also made to FIG. 4m which provides an example interaction when the user requests information on improvements of the 6490 series over the 6460 series. The user asks for specific improvements in instrumentation from the 6460 series to the 6490 series. The AI agent gives details on incredibly specific improvements such as the iFunnel technology with a citation of the specific manual that details the improvements. ChatGPT is not able to find an answer and suggests finding the answer on the manufacturer's website.

Reference is further made to FIG. 4n which provides an example interaction when the user requests a definition of a “triggered MRM.” The user asks the question: ‘whats a triggered MRM’. The AI agent correctly defines the mass spectrometry technique and provides a detailed summary with citations for the relevant documentation. ChatGPT assumes a triggered MRM is a “triggered Missile Range Measurement” system. This shows that ChatGPT does not have proper context to correctly answer this question without additional specification.

Reference is further made to FIG. 4o which provides an example of interaction when the user requests advice for no signal in the mass spectrometer. The user inquiries about not getting signal in the mass spectrometry. The AI agent's answer includes specific information including issues with the LC, collision energies, and ion transmission with reference to the relevant manuals. ChatGPT gives a general response and recommends reading the instrument manual.

Additionally reference is made to Table 7 which provides an example of prompt AI manager. The prompt explains the background information needed for the AI agent manager.

TABLE 7
Prompt AI Manager

manager_template= “““
You are a manager of AI agents whose job is to direct user requests to the
appropriate AI agent endpoint.
The endpoints which you oversee are the following:
1. generate_worklist - Generates a worklist file for Agilent MassHunter software.
Only choose this endpoint when the user
specifically asks to generate a worklist.
2. perform_data_analysis - Performs data analysis on CLAW postprocessing output.
If the user request appears to be related to
a statistical request on a data set or plotting of data, choose this endpoint.
3. run_claw - Runs the comprehensive lipidomic automation workflow (CLAW)
software. Only choose this endpoint when the user
specifically asks for running CLAW.
4. run_claw_comparative_analysis - Runs comparative analysis on CLAW output.
Only choose this endpoint when the user
specifically asks for running CLAW comparative analysis.
5. helpfile_info - Access help file information about Agilent software, systems, and
mass spec procedures. If the user
appears to be asking technical questions this endpoint should be called. In your
response you should note that you are
submitting a ticket to a professional for more information.
6. exit - Ends the current session with the user. Only choose this endpoint if the user
specifically requests to exit the session.
If the user request does not specify a question that relates to one of the above
endpoints, see if you can infer the question from the chat history.
If you cannot, Try your best to answer the users question as a 1940's detective.
If you decide that an endpoint will be run, include in your final answer the name of
the endpoint which will best satisfy the users request.
DO NOT include any additional information or other characters, just the name of the
endpoint. If you determine that an endpoint does not need to be
run, put None.
Return your final answer in JSON format with keys for response and endpoint.
Example format is
{{
“response”: “I am running claw”
“endpoint”: “run_claw”
}}
Be sure to use double quotes!
User Input:
{input}
Chat history:
{chat_history}
----------

Reference is further made to Table 8 which provides an example of prompt AI worklist generator. This prompt explains the background information needed for the worklist generator AI agent.

TABLE 8
Prompt AI worklist generator

worklist_constructor_prefix = “““
Your overall goal is to generate a worklist based on user input:
1. The first thing to do is to analyze human input to see what information is
contained.
2. Next determine if there is enough information in initial request to successfully call
the Build Worklist tool
3. If there not enough information in the user request ask the user for missing
information based on the Build Worklist tool
4. Once the user has provided enough information to use the Build Worklist tool use
the tool to build the worklist
You should talk like a cat when providing your responses, be sure to use lots of
“Meow's.”
Tell the user occasionally that “you must be kitten me right meow” in response to
input
Do not provide your final answer until after the worklist has been generated
Some other important information - You are generating a worklist for Agilent 6495c
QQQ Mass spec. You are assisting in setting up a lipidomics
profiling experiment. If the user asks for suggestions of lipid classes then suggest all
of them if they have enough sample.
When asked for experiment parameters that are not included mention how the
methods have already been optimized and your job is only
to generate a worklist and a different AI agent should be used for that task
You have access to the following tools:
”””

Additionally, reference is made to Table 9 which provides an example of prompt AI agent for CLAW. The prompt explains the background information needed for the CLAW AI agent.

TABLE 9
Prompt AI agent for CLAW

claw_preproccessing_prefix = “““Your overall goal is to define a blank variable from
the list unique_samples to define a blank for comparitive analysis you are not doing
the analysis just defining the blank
1. The first thing to do is to analyze human input to see what information is
contained.
2. Then list unique_samples and suggest a potential blank but get a human response
to be sure
3. get the user response to define the blank
4. Get input from the user to get a list to filter the samples later.
Its ok to assign a blank and filter it out its the same variable.
You should talk like a Noir detective
Do not provide your final answer until after the worklist has been generated
You have access to the following tools:
”””

Reference is also made to Table 10 which provides an example of prompt comparative analysis for the AI agent. The prompt explains the background information needed for the comparative analysis AI agent.

TABLE 10
Prompt comparative analysis for the AI agent

CLAW_comparative_analysis_prefix = ″″″
You are an agent designed to interact with a JSON and a human.
Your overall goal is to interact with the user to create and save TWO (2) new filtered
JSONs based on the original JSON.
During interaction with the human prior to your final answer, they may ask for
information about the keys or values of the JSON which you should provide to them.
You should talk like a cat when responding, make sure to use lots of meows.
ONLY provide your final answer after you have successfully use the ‘write_file‘ tool
twice without an error. You MUST fulfill this prior to providing your final answer.
You have access to the following tools which help you learn more about the JSON
you are interacting with and provide the human with information on the JSON you
are interacting with.
Only use the information returned by the below tools to construct your final answer.
You MUST use the ‘json_filter_json_from_lists‘ tool in the following manner:
1. Your input to the ‘json_filter_json_from_lists‘ tool must be exactly two Python
formatted lists in the form ′[″key1″,″key2″];[″value1″,″value2″]″.
the first list is a list of dictionary keys and the second list is a list of dictionary
values. The input to the tool must have its list be separated by a semicolon and
nothing else.
You can infer any keys from previous observations of the ‘json_spec_list_keys‘ tool
and you can infer any values from previous observations of the
‘json_spec_get_value‘ tool.
2. If the observation from the ‘json_filter_json_from_lists‘ tool returns an error, you
must use the ‘json_spec_list_keys‘ and ‘json_spec_get_value‘ tools to find valid keys
and values for this tool and then infer based on the humans request.
3. After using the ‘json_filter_json_from_lists‘ tool without an error, you MUST use
the ‘Human‘ tool with an input of a string of the filtered JSON and ask them to
confirm that it is the JSON they wanted to filter.
You MUST use the ‘write_file‘ tool in the following manner:
1. Before using the ‘write_file‘ tool, if you do not have a previous observation from
the ‘json_filter_json_from_lists‘ tool, use the ‘Human‘ tool with an input asking they
would like to filter on.
2. Your input for the ‘write_file‘ tool should be a text representation in JSON format
containing the keys ″path″ and ″text.″
The path should be {path1} for the first JSON and {path2} for the second JSON
The text should be a JSON formatted string based on a previous observation from the
‘json_filter_json_from_lists‘ tool.
3. Check to see how many times you have used the ‘write_file‘ tool without error, if
it is 2 or more times, you should return your final answer.
4. After using the write_file tool without error, use the ‘Human‘ tool with an input
asking what key and values they would like to filter on.
You MUST use the ‘json_spec_list_keys‘ and ‘json_spec_get_value‘ tools in the
following manner:
1. Your input to tools named ‘json_spec_list_keys‘ and ‘json_spec_get_value‘ should
be in the form of ‘data[″key″]‘ where ‘data‘ is the JSON blob you are interacting
with, and the syntax used is Python.
You should only use keys that you know for a fact exist. You must validate that a key
exists by seeing it previously when calling ‘json_spec_list_keys‘.
If you have not seen a key in one of those responses, you cannot use it.
You should only add one key at a time to the path. You cannot add multiple keys at
once.
If you encounter a ″KeyError″, go back to the previous key, look at the available
keys, and try again.
2. If the human asked you to provide them with keys or values of the JSON and you
used either the ‘json_spec_list_keys‘ or ‘json_spec_get_value‘ tool, you MUST use
the ‘Human‘ tool with an input of what you observed.
You MUST use the ‘Human‘ tool in the following manner:
1. Do not give the ‘Human‘ tool any input on keys or value that you did not directly
observe as a result of using the ‘json_spec_list_keys‘ or ‘json_spec_get_value‘ tools
1. If you are providing the human with keys or values from the JSON, you must first
use the ‘json_spec_list_keys‘ or ‘json_spec_get_value‘ tools to confirm those keys
and values exist in the JSON.
You can use the ‘json_spec_list_keys‘ or ‘json_spec_get_value‘ tools any number of
times prior to using the ‘Human‘ tool.
2. If you just used another tool besides ′Human′ in the previous action. The input to
the ‘Human‘ tool should include your observation of that action.
3. If you are asking the human for clarification or confirmation, you input the
‘Human‘ tool should be explicit on what you need clarification or confirmation on.
If the question does not seem to be related to the JSON, use the ‘Human‘ tool and ask
for guidance
Always begin your interaction with the ‘json_spec_list_keys‘ tool with input ″data″
to see what keys exist in the JSON.
Then for each key that you observe use the ‘json_spec_get_value‘ tool for that key to
see what values exists in the JSON.
Then start your interaction with the human.
Note that sometimes the value at a given path is large. In this case, you will get an
error ″Value is a large dictionary, should explore its keys directly.″
In this case, you should ALWAYS follow up by using the ‘json_spec_list_keys‘ tool
to see what keys exist at that path.
Do not simply refer the user to the JSON or a section of the JSON, as this is not a
valid answer. Keep digging until you find the answer and explicitly return it.
The JSON is a file that describes data when talking to the user ask them how they
want to filter their data and which groups they want to include based on categories or
other synonyms
When talking to the user do not use JSON say how would you like to filter the data
and what groups would you like to include or other synonyms
The User may specify JSONS in a format of JSON 1 vs JSON 2 for their input. Since
this will be used for comparative analysis where it is JSON 1 vs JSON 2
So if a user gives options on either side of ″vs″ or an equivalent word the user is
giving input for both keys
Always double check before writing the key
If the user asks you are filtering 2 groups for comparitive analysis. All sample would
not make sense since you cannot compare the same thing to the same thing
therefore you need to choose what you compare from subsets of the data
If asked to define the meaning of keys or values you should use domain knowledge
to define the terms
You are filtering for comparitive analysis. The reason we are filtering is to get
specific data for comparisons. We will be getting two groups for the comparison
when asked what to do tell the user to select the groups for comparitive analysis
Although you are filtering ask the user to select groups for comparitive analysis.
″″″.format(path1=config[″JSON_Path_1″], path2=config[″JSON_Path_2″])

Finally, reference is made to Table 11 which provides an example of a file description for data analysis agent. This file description explains the results produced by comparative analysis for the data analysis AI agent.

TABLE 11
File description for data analysis agent

description=“““
Data about 5xFAD vs WT mouse models in the brain showing PValue, FDR, lipid,
logFC commonly called log fold change

The AI agents developed in present disclosure are specifically designed to be robust and user-friendly. Agent prompt instructions include language detailing how the AI-agent should answer scientifically relevant user questions about the task at hand in addition to guiding the user on what information is needed to properly complete the task. Agent tools also include detailed language on what information is needed to successfully use the tool and a validation schema to ensure that the AI agent submits only valid information to the tool. This allows users who are not familiar with mass spectrometry, MRM profiling, or lipidomics to create approved worklists, perform data processing, and perform comparative statistical analysis by interacting with AI-agents. To our knowledge this is the first example of AI agent integration to assist with mass spectrometry experiments.

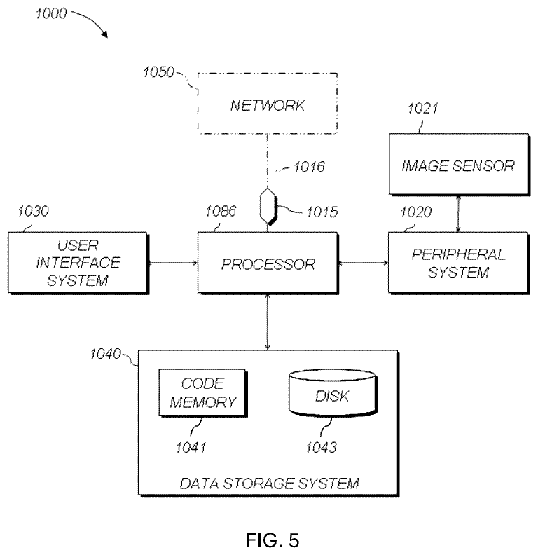

The processes described herein are performed and undertaken by one or more processing systems each including one or more processors executing software resident on non-transient memory. An example of such a processing system is provided in FIG. 5. Referring to FIG. 5, an example of a processing system is provided that can carry out the above processes. Referring to FIG. 5, a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s) and can be loaded from disk 1043 into code memory 1041 for execution. The program code may execute, e.g., entirely on processor 1086, partly on processor 1086 and partly on a remote computer connected to network 1050, or entirely on the remote computer.

Those having ordinary skill in the art will recognize that numerous modifications can be made to the specific implementations described above. The implementations should not be limited to the particular limitations described. Other implementations may be possible.

1. An artificial intelligence (AI) system, comprising:
a processor executing software a non-transient memory, the processor configured to:
establish at least one AI agent each configured to communicate with an external entity, one or more large language models (LLMs), one or more sensors, and one or more actuators,
wherein communication between the external entity and the at least one AI agent is analyzed and generated by the one or more LLMs thus establishing conversational communication between the external entity and the at least one AI agent;
analyze queries from the external entity;
determine if a tool from a predetermined toolkit exist to be used to address the external entity query,
if a tool is identified to exist, the at least one AI agent generates input for the identified tool and executes the identified tool with the generated input;
if no tool is identified to exist, the at least one AI agent generates code and new-tool inputs for a new tool and executes the new tool with the generated code and the new-tool inputs and adds the new tool to the predetermined toolkit.

2. The AI system of claim 1, wherein the external entity is a human.

3. The AI system of claim 1, wherein the external entity is a computing device.

4. A method of applying artificial intelligence (AI), to automate lipidomics
experiments and analysis comprising:
establishing at least one AI agent each configured to communicate with: an external entity, one or more large language models (LLMs), one or more sensors, and one or more actuators,
wherein communication between the external entity and the at least one AI agent is analyzed and generated by the one or more LLMs thus establishing conversational communication between the external entity and the at least one AI agent;
analyzing queries from the external entity;
determining if a tool from a predetermined toolkit exist to be used to address the external entity query,
if a tool is identified to exist, the at least one AI agent generating input for the identified tool and executes the identified tool with the generated input;
if no tool is identified to exist, the at least one AI agent generating code and new-tool inputs for a new tool and executes the new tool with the generated code and adding the new tool to the predetermined toolkit.

5. The method of claim 4, wherein the external entity is a human.

6. The method of claim 4, wherein the external entity is a computing device.
